(19) United States
(12) Patent Application Publication
(10) Pub. No.: US 2015/0039274 A1
(43) Pub. Date: Feb. 5, 2015

(54) SYSTEM AND METHOD FOR PERSONALIZED METABOLIC MODELING

(71) Applicant: Ramot at Tel-Aviv University Ltd., Tel Aviv (IL)

(72) Inventors: Eytan RUPPIN, Modiin-Macabim-Reut (IL); Keren YIZHAK, Netanya (IL)

(21) Appl. No.: 14/173,299

(22) Filed: Feb. 5, 2014

Related U.S. Application Data
(60) Provisional application No. 61/760,731, filed on Feb. 5, 2013.

(51) Int. Cl. G06F 19/12; G06F 19/00

(52) U.S. Cl. CPC G06F 19/12; G06F 19/3437
USPC 703/2

(57) ABSTRACT

A processor implemented method for personalized metabolic modeling starting from a generic metabolic model. For each reaction Ri in the generic metabolic model, a correlation ρ(i) between the expression level of the reaction and the level of a quantifiable phenotype in a population of cells is calculated. A set of highly correlated reactions is identified. An expression matrix, Exp-matrix, is then calculated which is used to generate the personalized metabolic model.

### CROSS REFERENCES TO RELATED APPLICATIONS

The present application claims the benefit of U.S. Provisional Patent Application No. 61/760,731, entitled “System and Method for Personalized Metabolic Modeling”, filed on Feb. 5, 2013, the disclosure of which is incorporated herein by reference in its entirety for all purposes.

### FIELD OF THE INVENTION

The present invention relates to systems and methods in computational biology.

### BACKGROUND OF THE INVENTION

The following publications are listed below for an understanding of the background of the invention.
1. Frueh, F. W. et al. Pharmacogenomic Biomarker Information in Drug Labels Approved by the United States Food and Drug Administration: Prevalence of Related Drug Use. Pharmacotherapy: The Journal of Human Pharmacology and Drug Therapy 28, 992-998 (2008).
2. Simon, R. & Roychowdhury, S. Implementing personalized cancer genomics in clinical trials. Nat Rev Drug Discov 12, 358-369 (2013).
3. Editorial: What happened to personalized medicine? Nat Biotech 30, 1-1 (2012).
4. Nicholson, J. K. Global systems biology, personalized medicine and molecular epidemiology. Mol Syst Biol 2 (2006).
5. Burgard, A. P., Pharkya, P. & Maranas, C. D. Optknock: A bilevel programming framework for identifying gene knockout strategies for microbial strain optimization. Biotechnol Bioeng 84, 647-657 (2003).
6. Lewis, N. E. et al. Large-scale in silico modeling of metabolic interactions between cell types in the human brain. Nat Biotech 28, 1279-1285 (2010).
7. Jensen, P. A. & Papin, J. A. Functional integration of a metabolic network model and expression data without arbitrary thresholding. Bioinformatics 27, 541-547 (2010).
8. Chandrasekaran, S. & Price, N. D. Probabilistic integrative modeling of genome-scale metabolic and regulatory networks in Escherichia coli and Mycobacterium tuberculosis. Proceedings of the National Academy of Sciences 107, 17845-17850 (2010).
9. Oberhardt, M. A., Palsson, B. O. & Papin, J. A. Applications of genome-scale metabolic reconstructions. Mol Syst Biol 5 (2009).
10. Wessely, F. et al. Optimal regulatory strategies for metabolic pathways in Escherichia coli depending on protein costs. Mol Syst Biol 7 (2011).
11. Agren, R. et al. Reconstruction of Genome-Scale Active Metabolic Networks for 69 Human Cell Types and 16 Cancer Types Using INIT. PLoS Comput Biol 8, e1002518 (2012).
12. Schuetz, R., Zamboni, N., Zampieri, M., Heinemann, M. & Sauer, U. Multidimensional Optimality of Microbial Metabolism. Science 336, 601-604 (2012).
13. Szappanos, B. et al. An integrated approach to characterize genetic interaction networks in yeast metabolism. Nat Genet 43, 656-662 (2011).
14. Lerman, J. A. et al. In silico method for modelling metabolism and gene product expression at genome scale. Nat Commun 3, 929 (2012).
15. Lee, D. et al. Improving metabolic flux predictions using absolute gene expression data. BMC Systems Biology 6, 73 (2012).
16. Pey, J., Rubio, A., Theodoropoulos, C., Cascante, M. & Planes, F. J. Integrating tracer-based metabolomics data and metabolic fluxes in a linear fashion via Elementary Carbon Modes. Metabolic Engineering 14, 344-353 (2012).
17. Duarte, N. C. et al. Global reconstruction of the human metabolic network based on genomic and bibliomic data. Proc Natl Acad Sci USA 104, 1777-1782 (2007).
18. Ma, H. et al. The Edinburgh human metabolic network reconstruction and its functional analysis. Mol Syst Biol 3 (2007).
19. Lee, D. S. et al. The implications of human metabolic network topology for disease comorbidity. Proceedings of the National Academy of Sciences 105, 9880-9885 (2008).
20. Shlomi, T., Cabili, M. N. & Ruppin, E. Predicting metabolic biomarkers of human inborn errors of metabolism. Mol Syst Biol 5 (2009).
21. Shlomi, T., Cabili, M. N., Herrgard, M. J., Palsson, B.Ø. & Ruppin, E. Network-based prediction of human tissue-specific metabolism. Nature Biotechnology 26, 1003-1010 (2008).
22. Jerby, L., Shlomi, T. & Ruppin, E. Computational reconstruction of tissue-specific metabolic models: application to human liver metabolism. Mol Syst Biol 6 (2010).
23. Folger, O. et al. Predicting selective drug targets in cancer through metabolic networks. Mol Syst Biol 7, 501 (2011).
24. Frezza, C. et al. Haem oxygenase is synthetically lethal with the tumour suppressor fumarate hydratase. Nature 477, 225-228 (2011).
25. Price, N. D., Reed, J. L. & Palsson, B. O. Genome-scale models of microbial cells: evaluating the consequences of constraints. Nat Rev Microbiol 2, 886-897 (2004).
26. Colijn, C. et al. Interpreting Expression Data with Metabolic Flux Models: Predicting Mycobacterium tuberculosis Mycolic Acid Production. PLoS Comput Biol 5, e1000489 (2009).
27. Duarte, N. et al. Global reconstruction of the human metabolic network based on genomic and bibliomic data. Proc Natl Acad Sci USA 104, 1777-1782 (2007).
28. Benjamini, Y. & Hochberg, Y. Controlling the False Discovery Rate: A Practical and Powerful Approach to Multiple Testing. Journal of the Royal Statistical Society. Series B (Methodological) 57, 289-300 (1995).
29. Varma, A. & Palsson, B. O. Metabolic flux balancing: Basic concepts, scientific and practical use. Bio. Technology 12, 994-998 (1994).
30. Consortium, I. A haplotype map of the human genome. Nature 27, 1299-1320 (2005).
31. Choy, E. et al. Genetic Analysis of Human Traits In Vitro: Drug Response and Gene Expression in Lymphoblastoid Cell Lines. PLoS Genet 4, e1000287 (2008).
32. Stark, A. L. et al. Population Differences in the Rate of Proliferation of International HapMap Cell Lines. The American Journal of Human Genetics 87, 829-833 (2010).
33. Lee, J. K. et al. A strategy for predicting the chemosensitivity of human cancers and its application to drug discovery. Proceedings of the National Academy of Sciences 104, 13086-13091 (2007).
34. Barretina, J. et al. The Cancer Cell Line Encyclopedia enables predictive modelling of anticancer drug sensitivity. Nature 483, 603-307 (2012).
35. Cheung, H. W. et al. Systematic investigation of genetic vulnerabilities across cancer cell lines reveals lineage-specific dependencies in ovarian cancer. Proceedings of the National Academy of Sciences 108, 12372-12377 (2011).
36. Lock, E. F. et al. Quantitative High-Throughput Screening for Chemical Toxicity in a Population-Based In Vitro Model. Toxicological Sciences 126, 578-588 (2012).
37. Garnett, M. J. et al. Systematic identification of genomic markers of drug sensitivity in cancer cells. Nature 483, 570-575 (2012).
38. Scherf, U. et al. A gene expression database for the molecular pharmacology of cancer. Nat Genet 24, 236-244 (2000).
39. Holbeck, S. L., Collins, J. M. & Doroshow, J. H. Analysis of Food and Drug Administration-Approved Anticancer Agents in the NCI60 Panel of Human Tumor Cell Lines. Molecular Cancer Therapeutics 9, 1451-1460 (2010).
40. Wishart, D. S. et al. DrugBank: A knowledge-base for drugs, drug actions and drug targets. Nucleic Acids Research 36, D901-D906 (2008).
41. Cheong, H., Lu, C., Lindsten, T. & Thompson, C. B. Therapeutic targets in cancer cell metabolism and autophagy. Nat Biotech 30, 671-678 (2012).
42. Curtis, C. et al. The genomic and transcriptomic architecture of 2,000 breast tumours reveals novel subgroups. Nature 486, 346-352 (2012).
43. McGarry J D, M. S., Long C S, Foster D W Observations on the affinity for carnitine, and malonyl-CoA sensitivity, of carnitine palmitoyltransferase I in animal and human tissues. Biochem J. 214, 21-28 (1983).
44. Chang, H. Y. et al. Robustness, scalability, and integration of a wound-response gene expression signature in predicting breast cancer survival. Proceedings of the National Academy of Sciences of the United States of America 102, 3738-3743 (2005).
45. Miller, L. D. et al. An expression signature for p53 status in human breast cancer predicts mutation status, transcriptional effects, and patient survival. Proceedings of the National Academy of Sciences of the United States of America 102, 13550-13555 (2005).
46. Pawitan, Y. et al. Gene expression profiling spares early breast cancer patients from adjuvant therapy: derived and validated in two population-based cohorts. Breast Cancer Research 7, R953-R964 (2005).
47. Kaplan, E. L. & Meier, P. Nonparametric Estimation from Incomplete Observations. Journal of the American Statistical Association 53, 457-481 (1958).
48. Grambsch, T. M. T. a. P. M. Modeling survival data: extending the Cox Model. Springer (2000).
49. Elston, C. W. & Ellis, I. O. pathological prognostic factors in breast cancer. I. The value of histological grade in breast cancer: experience from a large study with long-term follow-up. Histopathology 19, 403-410 (1991).
50. Fitzgibbons, P. L. et al. Prognostic Factors in Breast Cancer. Archives of Pathology & Laboratory Medicine 124, 966-978 (2000).
51. Dallas, N. A. et al. Chemoresistant Colorectal Cancer Cells, the Cancer Stem Cell Phenotype, and Increased Sensitivity to Insulin-like Growth Factor-I Receptor Inhibition. Cancer Research 69, 1951-1957 (2009).
52. Simstein, R., Burow, M., Parker, A., Weldon, C. & Beckman, B. Apoptosis, Chemoresistance, and Breast Cancer: Insights From the MCF-7 Cell Model System. Experimental Biology and Medicine 228, 995-1003 (2003).
53. Jiang, Z. et al. The role of estrogen receptor alpha in mediating chemoresistance in breast cancer cells. Journal of Experimental & Clinical Cancer Research 31, 1-10 (2012).
54. Jerby, L. et al. Metabolic associations of reduced proliferation and oxidative stress in advanced breast cancer. Cancer Research (2012).
55. Hatzikirou, H., Basanta, D., Simon, M., Schaller, K. & Deutsch, A. ^{˜}Go or Grow”: the key to the emergence of invasion in tumour progression? Mathematical Medicine and Biology 29, 49-65 (2010).
56. Segre, D., Vitkup, D. & Church, G. M. Analysis of optimality in natural and perturbed metabolic networks. Proc Natl Acad Sci USA 99, 15112-15117 (2002).
57. Bordel, S., Agren, R. & Nielsen, J. Sampling the Solution Space in Genome-Scale Metabolic Networks Reveals Transcriptional Regulation in Key Enzymes. PLoS Comput Biol 6, e1000859 (2010).
58. Gonzalez-Malerva, L. et al. High-throughput ectopic expression screen for tamoxifen resistance identifies an atypical kinase that blocks autophagy. Proceedings of the National Academy of Sciences 108, 2058-2063 (2010).
59. Peters, D., Freund, J. & Ochs, R. L. Genome-wide transcriptional analysis of carboplatin response in chemosensitive and chemoresistant ovarian cancer cells. Molecular Cancer Therapeutics 4, 1605-1616 (2005).
60. Hou, X. et al. Drug Efflux by Breast Cancer Resistance Protein Is a Mechanism of Resistance to the Benzimidazole Insulin-Like Growth Factor Receptor/Insulin Receptor Inhibitor, BMS-536924. Molecular Cancer Therapeutics 10, 117-125 (2011).
61. Selga, E. et al. Networking of differentially expressed genes in human cancer cells resistant to methotrexate. Genome Medicine 1, 1-16 (2009).
62. http://dtp.nci.nih.gov/docs/misc/common_files/cell_list.html.

Personalized medicine is moving us closer to a more precise, predictable and powerful method of treatment, that is customized for the individual patient. In this new era, the tools at hand can probe the very molecular makeup of each patient, thus enabling better diagnoses and a more effective treatment of the disease. It is estimated that already 10% of FDA-approved drugs contain pharmacogenomic information, and these drugs are administered differently to people with different ethnic or genetic backgrounds¹. One field of research in which personalized medicine holds great promise is cancer therapy. The use of genetic markers to ‘personalize’ cancer treatment and to differentiate one type of cancer from another will facilitate the use of highly tailored therapies and offers tremendous potential for improved prognoses². Recently, it has become clearer that advances in personalized medicine will require going beyond the genomics, and aiming to develop large-scale functional physiological models³. In particular, various disciplines in systems biology have been suggested as promising approaches towards personalized and stratified medicine⁴.

Constraint-Based Modeling (CBM) is a computational framework for studying metabolism on a genome-scale, which has been used for a variety of applications⁵⁻¹⁶. In recent years, two genome scale models of human metabolism have been published^{17, 18}. Their potential clinical utility was demonstrated in various studies; e.g., identifying reactions causally related to hemolytic anemia, predicting drug targets for hypercholesterolemia¹⁷, studying disease co-morbidity¹⁹ and pinpointing diagnostic biomarkers for inborn errors of metabolism²⁰. While these human models are genome-wide and are thus not specific to any mature cell or tissue-type, they have also successfully served as a basis for generating context-specific models of tissues^{11, 21, 22} and for studying cancer metabolism^{23, 24}. Building such context-specific models typically requires identifying those reactions in a genome-wide model that need not be considered due to low gene expression or other omics-data).

A metabolic network consisting of m metabolites and n reactions can be represented by a stoichiometric matrix S, where the entry Sᵢⱼ represents the stoichiometric coefficient of metabolite i in reaction j²⁵. A CBM model imposes mass balance, directionality and flux capacity constraints on the space of possible fluxes in the metabolic network's reactions through the set of linear equations:

S·v=0 (1)

vₘᵢₙ≦v≦ (2)

where v is the flux vector for all of the reactions in the model (i.e. the flux distribution). The exchange of metabolites with the environment is represented as a set of exchange (transport) reactions, enabling a pre-defined set of metabolites to be either taken up from, or secreted to, the growth medium. The steady-state assumption represented in Equation (1) constrains the production rate of each metabolite to be equal to its consumption rate. Enzymatic directionality and flux capacity constraints define lower and upper bounds on the fluxes and are embedded in Equation (2). Gene knock-outs are simulated by constraining the flux through the corresponding metabolic reaction to be zero.

### SUMMARY OF THE INVENTION

Embodiments of the present invention provide a system and method for generating a personalized metabolic model. As explained below, embodiments utilize gene expression measurements and phenotypic data to produce personalized metabolic models that differ in the bounds set on the reaction fluxes.

Embodiments can be used to construct distinct metabolic models of cells that are similar in their gene expression signatures to produce differentiated, case-specific models. As explained below, a method of the invention modifies the upper bounds of only a subset of the reactions in a generic model which are associated with a predetermined phenotype (e.g., proliferation rate) in accordance with gene expression levels. This is in contrast, for example, to a prior art method known as “E-Flux”, which changes the bounds of all enzyme-associated reactions in the network²⁶

The method of the invention uses three inputs: (1) for each of p cells, a level of a quantifiable phenotype of the cell under predetermined conditions, (2) a generic metabolic model to be personalized, involving reactions occurring in the p cells, and, (3) for each of the p cells, and for each of one or more enzymes catalyzing a reaction in the generic model, an expression level in the cell of the gene encoding for the enzyme.

The method is generic and can be used with any metabolic model of the cells, and any quantifiable phenotype. The generic metabolic model may be, for example, the human model²⁷ and may be specified by the equations (1) and (2) above. The quantifiable phenotype may be, for example, the growth rate of the cell under predetermined conditions.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1a shows a flow chart of an algorithm for generating a personalized metabolic model in accordance with one embodiment of the invention;

FIG. 1b shows a flow chart for a method for calculating minNormVal in accordance with one embodiment of the invention;

FIG. 1c shows a flow chart for a method for calculating maxNormVal.

FIG. 2 shows a piecewise linear curve representing the change in biomass production as a function of upper bounds in the in the human generic metabolic model;

FIG. 3 shows a block diagram of a computer system suitable for implementing the present invention;

FIG. 4a shows the Spearman correlation achieved by the different methods in predicting the individualized growth rates measurements across the HapMap and NCI-60 cell-lines;

FIG. 4b shows a comparison between mean predicted and measured growth rates across the four HapMap populations;

FIG. 4c shows a comparison between mean predicted and measured growth rates across the nine tumor types composing the NCI-60 collection;

FIG. 4d shows a distribution of hypergeometric P-values achieved by either the core set of essential genes predicted by the generic model (black); the addition of predictions in accordance with the invention (light blue); or by analyzing the gene expression alone (red);

FIG. 5a shows a comparison between measured and predicted drug response for the HapMap, CEU (Western European ancestry) and NCI-60 datasets;

FIG. 5b shows core metabolic pathways and metabolic enzymes that carry known and/or predicted cancer therapeutic targets, in which metabolic enzymes colored green are a subset of known cytostatic drug targets, metabolic enzymes colored red are those found in current clinical trials, out of which those marked by an asterisk were identified as selective targets by the invention, metabolic enzymes colored blue denote novel selective predictions by the invention;

FIG. 5c shows a schematic description of metabolic changes following Malonyl-CoA Decarboxylase (MLYCD) knockdown;

FIG. 6a shows MLYCD mRNA expression upon nucleofection with Non Targeting Control (NTC) and three independent siRNA constructs in HapMap (left) and RPMI-8226 (right) cells;

FIG. 6b shows cell proliferation of HapMap (left) and RPMI-8226 (right) cells upon MLYCD knockdown (siRNA);

FIG. 6c shows MLYCD mRNA expression upon infection with Non-Targeting Control (NTC) and two independent shRNA constructs in RPMI-8226 cells;

FIG. 6d shows the ratio between reduced (GSH) and oxidized (GSSG) glutathione in RPMI-8226 cells infected with the indicated constructs;

FIG. 6e shows cell proliferation of the indicated cell-lines in the presence or absence of 2 mM N-Acetyl Cysteine;

FIG. 7 shows Kaplan-Meier survival analysis for four breast cancer datasets;

FIG. 8a shows MLYCD mRNA expression upon nucleofection with Non-Targeting Control (NTC) and three independent siRNA constructs in K562 leukemia cells (left), and cell proliferation of K562 cells (right) upon MLYCD knock-down (siRNA);

FIG. 8b shows different expression of MLYCD among the different cells-lines;

FIG. 8c shows the functional inactivation of MLYCD resulted in a substantial decrease of acyl-carnitines, consistent with the expected inhibition of carnitine-palmitoyl transferase (CPT) by Malonyl-Coa. ** P-value <0.01; *** P-value <0.001.

FIG. 9 shows the difference in predicted growth rates between chemo-sensitive and chemo-resistant cancer cells as derived from their corresponding models (one-sided Wilcoxon P-value=1.35e-4). The plot represents the empirical cumulative distribution function for the predicted growth rates of the two groups.

### DESCRIPTION OF THE INVENTION

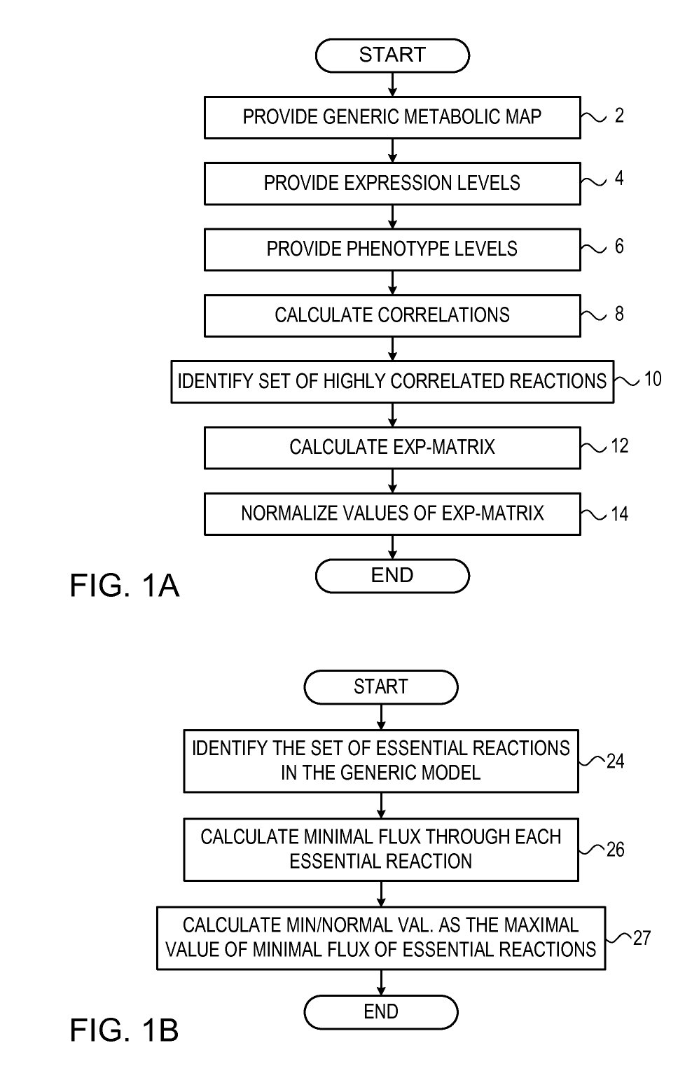

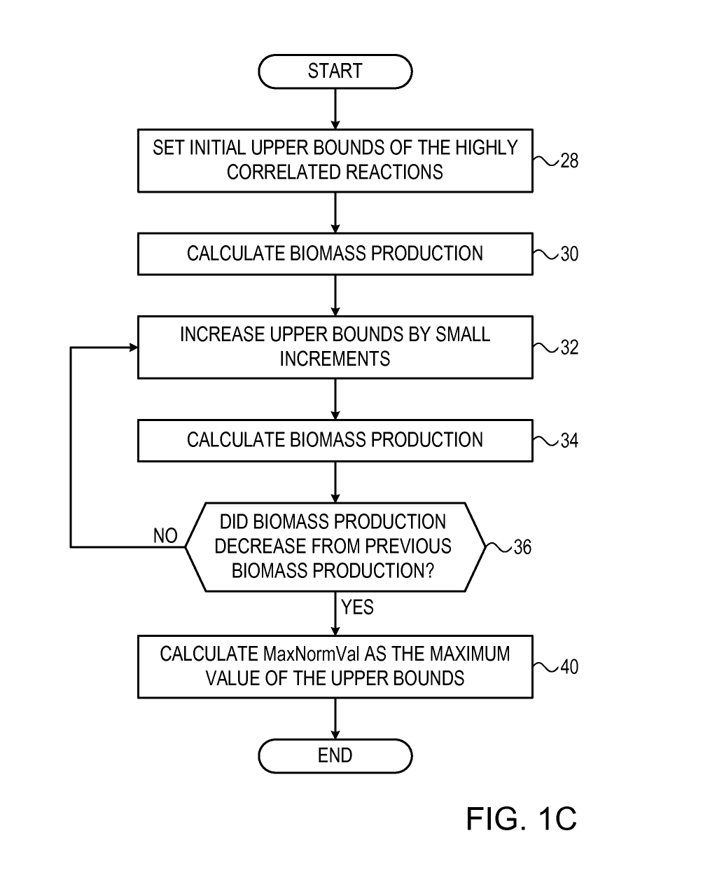

FIG. 1a is a flowchart of a method for generating a personalized metabolic model in accordance with one embodiment of the invention.

In step 2, a generic metabolic model of an organism is provided in which the forward and backward reaction of each reversible reaction in the generic model appears separately. In step 4, for each of two or more reactions in the metabolic model, an expression level of the reaction in each cell in a population of p predetermined cells is provided. The expression of a reaction in a cell may be defined, for example, as the mean expression level of the genes encoding the catalyzing enzymes of the reaction. A significance threshold is set, for example, by a false discovery rate (FDR) analysis as disclosed, for example, in Benjamini et al.²⁸ with α=0.05.

In step 6, a level of a predetermined quantifiable phenotype is provided for each of the p cells. In step 8, for each reaction Ri in the generic metabolic model, a correlation ρ(i) is calculated between (a) the expression level of the gene or genes encoding for the enzyme catalyzing the reaction and (b) the level of the quantifiable phenotype of the cell. The correlation is calculated over the population of the p cells.

Then, in step 10, a set t of reactions, referred to herein as ‘the highly correlated reactions’, is identified whose correlation with the phenotype level is above a predetermined threshold.

In step 12, a (t×p) expression matrix, referred to herein as the “Exp-matrix”, is calculated. The Exp-matrix has elements E_{i,j}, given by

$${E}_{i , j} = \frac{{ρ}_{i}}{\vert {ρ}_{i} \vert} \cdot {GE}_{i , j} \qquad ( 3 )$$

where GE_{i,j} is the input expression level of reaction i in the cell j.

The Exp-matrix embeds information relating to the direction and magnitude of change of the upper bound based on the expression levels. Due to the factor ρᵢ/|ρᵢ| for reactions whose expression is positively correlated with growth rate (ρ(i)>0), as the expression GE_{i,j} increases, Eᵢⱼ also increases (becomes more positive). For negatively correlated reactions (ρ(i)<0), as the expression, GEᵢⱼ, increases, Eᵢⱼ decreases (becomes more negative).

In step 14, the values of the Exp-matrix are preferably normalized in order to adapt the values of the Exp-matrix to the actual upper bounds. In the normalization procedure, each reaction i is normalized across the p cells so that (a) the lower bound associated with the cell having the lowest expression value is assigned the minimal value of the normalization range, and (b) the upper bound associated with the cell having the highest expression value is assigned the maximal value of the normalization range.

The process then terminates.

The normalization of the values of the Exp-matrix in step 14 may be performed, for example, by calculating a matrix UBᵢⱼ given by the algebraic expression:

$${UB}_{i , j} = ( \frac{{E}_{i , j} - min ( {E}_{i} )}{max ( {E}_{i} ) - min ( {E}_{i} )} \cdot ( maxNormVal - minNormVal ) ) + minNormVal \qquad ( 5 )$$

where min(Eᵢ) and max(Eᵢ) are the minimal and maximal values, respectively, of reaction i across all p cells in the Exp-matrix, “minNormVal” and maxNormVal are the minimal value and the maximal value, respectively, of the normalization range, and may be calculated as the minimal flux and maximal flux, respectively, necessary for biomass production.

minNormVal may be computed, for example, using a Flux Variability Analysis, for example, as disclosed in Varma et al.²⁹, over the set of essential reactions in the model. In order to define the maximal value of this range (maxNormVal), changes in the biomass production may be examined as a function of the generic model's upper bound. maxNormVal can then be defined as the value beyond which the resulting changes in the biomass production become smaller.

FIG. 1b is a flowchart for a method for calculating minNormVal. In step 24 the set of essential reactions in the generic model is identified, for example, using a Flux Balance Analysis⁵³. This set is composed of those reactions whose knockout reduces the phenotype level by more than a predetermined level, such as 90% of its maximal level.

In step 26, the minimal flux through each essential reaction is calculated, for example using a Flux Variability Analysis, such as described in Varma et al.²⁹. As each of these reactions is necessary for biomass production, reducing the upper bound of a reaction below its minimal flux value would result in cell death. In step 27, minNormVal is calculated, for example, as the maximal value of minimal flux of all of the essential reactions. The process then terminates.

FIG. 1c shows a flow chart for a method for calculating maxNormVal. In step 28, the upper bounds of the reactions highly correlated with the predetermined phenotype are set, and in step 30, a rate of biomass production is calculated. Then, in step 32, the upper bounds of the highly correlated reactions are increased by a small increment, such as of 0.1, and in step 34 the rate of biomass production is recalculated. In step 36 it is determined whether the rate of biomass production decreased as a result of the last increase in the upper bounds. If yes, then in step 40, maxNormVal is calculated as the maximal value of the current values of the upper bounds. If in step 36 it is determined that the rate of biomass production did not decrease as a result of the last increase in the upper bounds, the process returns to step 32 with the upper bounds being again increased by a small increment.

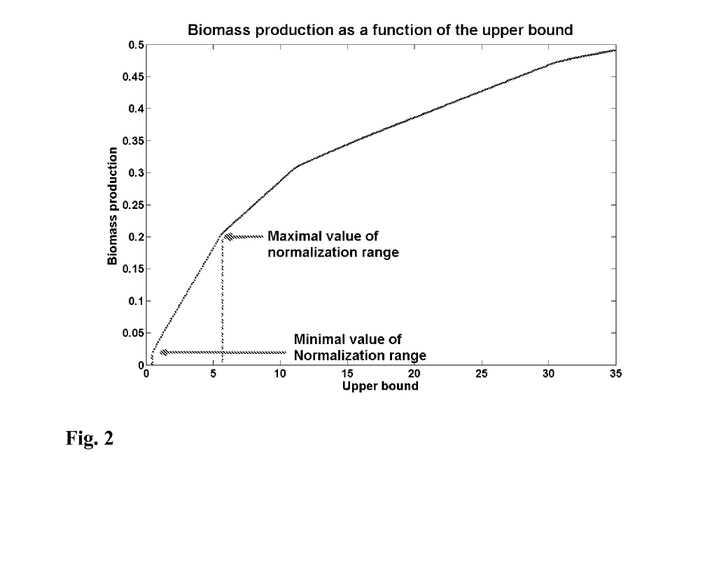

FIG. 2 shows the change in biomass production as a function of the upper bound in the generic human metabolic model. It was found that the dependence of the biomass production on the upper bound of a reaction that is highly correlated with the predetermined phenotype can be represented by a piecewise linear curve. The upper bound was gradually increased incrementally, starting from a minimal flux necessary for growth (indicated by the lower arrow in FIG. 2) as estimated over the subset of essential reactions, to the maximal bound in the model. The upper bound is the upper endpoint of the first linear segment (indicated by the higher arrow in FIG. 2). The normalization range can thus be defined as the range of upper bounds whose corresponding biomass production lies on the first linear segment of the graph. The biomass function utilized here is taken from Folger, O. et al.²³.

### Computer Implementation

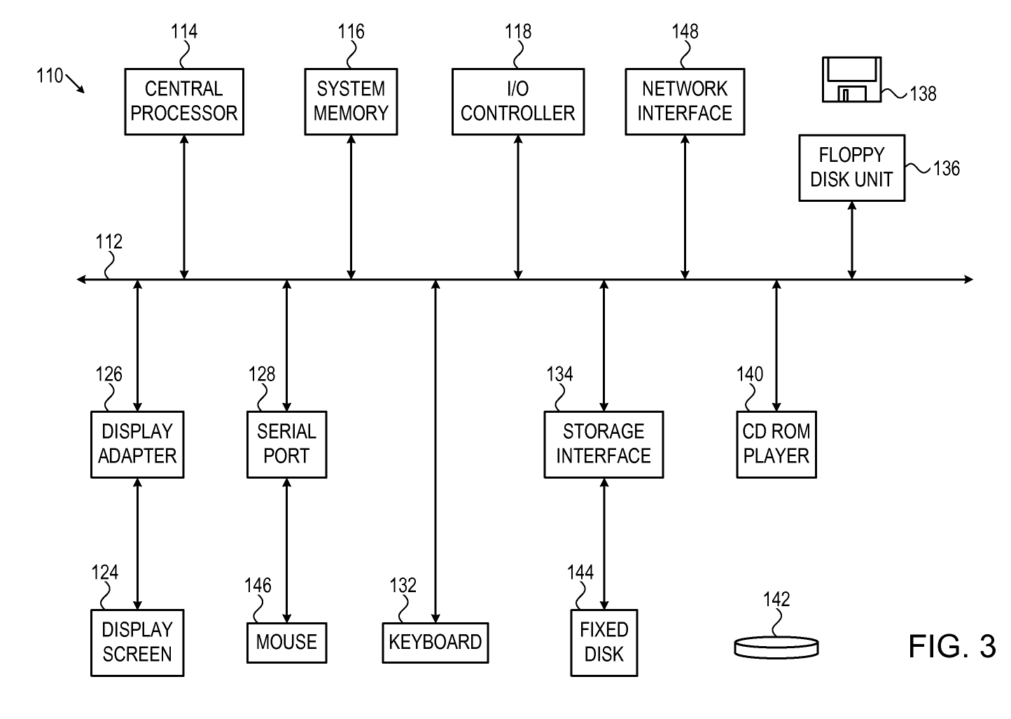

FIG. 3 depicts a block diagram of a host computer system 110 suitable for implementing the present invention. This diagram is merely an illustration and should not be considered as in anyway limiting the scope of the claims herein. One of ordinary skill in the art would recognize other variations, modifications, and alternatives. Host computer system 110 includes a bus 112 which interconnects major subsystems such as a central processor 114, a system memory 116 (typically RAM), an input/output (I/O) controller 118, an external device such as a display screen 124 via a display adapter 126, a keyboard 132 and a mouse 146 via an I/O controller 118, a SCSI host adapter (not shown), and a floppy disk drive 136 operative to receive a floppy disk 138. Storage Interface 134 may act as a storage interface to a fixed disk drive 144 or a CD-ROM player 140 operative to receive a CD-ROM 142. Fixed disk 144 may be a part of host computer system 110 or may be separate and accessed through other interface systems.

The system has other features. A network interface 148 may provide a direct connection to a remote server via a telephone link or to the Internet. Network interface 148 may also connect to a local area network (LAN) or other network interconnecting many computer systems. Many other devices or subsystems (not shown) may be connected in a similar manner. Furthermore, it is not necessary for all of the devices shown in Supplementary FIG. 3 to be present in order to practice the present invention, as discussed below. The devices and subsystems may be interconnected in different ways from that shown in FIG. 3. The operation of a computer system such as that shown in Supplementary FIG. 3 is readily known in the art and is not discussed in detail in this application. The databases and code required to implement embodiments of the present invention may be operably disposed or stored in computer-readable storage media such as system memory 116, fixed disk 144, CD-ROM 140, Flash memory or floppy disk 138.

Although the above has been described generally in terms of specific hardware, it would be readily apparent to one of ordinary skill in the art that many system types, configurations, and combinations of the above devices are suitable for use in light of the present disclosure. Of course, the types of system elements used depend highly upon the application.

### Results

### Example

### Constructing and Testing Personalized Metabolic Models of Normal Lymphoblasts and Cancer Cell Lines

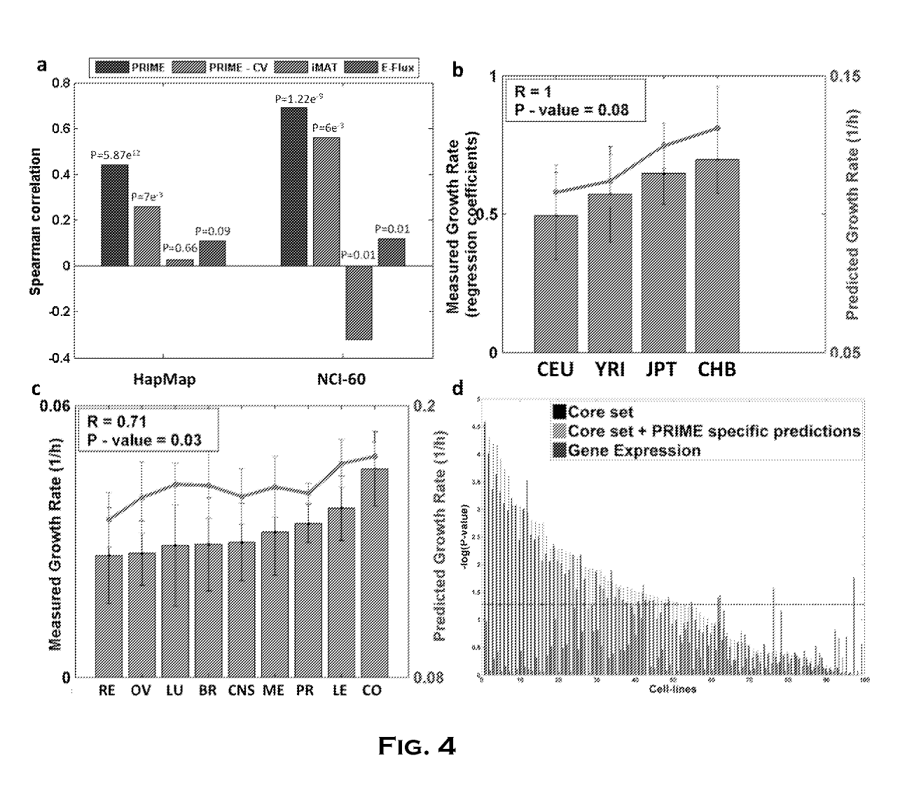

The invention was applied to a dataset composed of 224 lymphoblast cell-lines from the HapMap project³⁰, for which both gene expression and growth rate measurements are available³¹. This dataset is composed of cell-lines taken from healthy human individuals from four different populations, including Caucasian (CEU), African (YRI), Chinese (CHB) and Japanese (JPT) ethnicities. Applying the invention to the generic human model¹⁷, the corresponding 224 personalized metabolic models were constructed, one for each cell-line. The correlation between the growth rates predicted by these models and those measured experimentally is highly significant (Spearman R=0.44, P-value=5.87e-12, FIG. 4a). Furthermore, the personalized models correctly predicted the experimentally observed significant differences between population growth rates (CEU <YRI <JPT <CHB) in the correct order (FIG. 4b and Stark et al.³²). The correlation observed remains significant after employing a 5-fold cross validation process controlling for the (indirect) use of growth rate in determining the modified reaction set (Spearman R=0.26, empirical P-value=0.007, FIG. 4a,).

Embodiments of the invention was also applied to build individual models and predict the proliferation rates of 60 cancer cell-lines (the NCI-60 dataset³³), obtaining a highly significant correlation between the measured and predicted growth rates (Spearman R=0.69, P-value=1.22e-9, FIG. 2, panel a). A 4-fold cross-validation analysis resulted with a mean correlation of 0.56 (empirical P-value=0.006, FIG. 4a,). Grouping the samples into groups corresponding to the 9 tumor types found in this dataset and evaluating the mean growth rate of each group, a significant correlation was obtained between the measured and actual growth rates of the different tumors (Spearman R=0.71, P-value=0.03, FIG. 4c). Modifying the bounds of either all enzyme-associated reactions or random sets of reactions, resulted in inferior performance in both datasets (empiric P-value <9.9e-4,).

Two contemporary model-building methods failed to achieve highly significant results in these tasks: iMAT, an omics-integration method that defines a subset of active and inactive reactions based on expression data²¹, resulted in insignificant or even negative correlations between the actual and predicted growth rates for both datasets (HapMap: Spearman R=0.03, P-value=0.66; NCI-60: Spearman R=−0.32, P-value=0.01, FIG. 4a). This may be due to the high correlation in metabolic gene expression between samples (mean pair-wise Spearman R=0.97 and R=0.92 for the HapMap and NCI-60 datasets, respectively). E-flux²⁶ similarly failed to obtain meaningful results (HapMap: Spearman R in the range of 0.09-0.11, P-value >0.07; NCI-60: Spearman R in the range of −0.3-0.12, P-value >0.01, FIG. 4a, and Table 1).

TABLE 1
Correlation results of the E-Flux² method

| | HapMap | | NCI-60 | |
|---|---|---|---|---|
| | Spearman | P- | Spearman | P- |
| | Correlation | value | Correlation | value |
| Expression value | 0.09 | 0.17 | −0.27 | 0.03 |
| Sigmoidal | 0.08 | 0.18 | 0.11 | 0.18 |
| Exponential | 0.07 | 0.27 | 0.12 | 0.35 |
| Polynomial | 0.11 | 0.09 | −0.3 | 0.01 |

To further test the universality of growth-associated genes and reactions that have been identified across the NCI-60 cancer cell-lines, an embodiment of the invention was used to build a metabolic model for each of the 99 cancer cell-lines found in the Achilles dataset^{34, 35}. Specifically, the set of growth-associated genes identified in the NCI-60 dataset, together with the Achilles cell-lines' gene expression, was used to reconstruct the corresponding cell specific models. Comparing the predicted and measured growth rates, a significant correlation was found (Spearman R=0.65, P-value=0.01). Finally, the ability of the Achilles models and of the generic human model to predict gene essentiality was examined. The core set of essential genes identified by the generic model was predictive for up to 45 cell-lines (hyper-geometric P-value <0.05, FDR corrected with α=0.1, FIG. 4d). Nevertheless, extending this core set with additional genes predicted to be essential in each corresponding cell-line, a more significant correlation was obtained for up to 82% of the cell-lines, and overall provided significant results for up to 53 cell-lines (hyper-geometric P-value <0.05, FDR corrected with α=0.1, FIG. 4d). Of note, extending the core set by adding random genes of the same size did not enhance the prediction achieved by the generic model (empiric P-value <9.9e-4, Methods). Furthermore, inferring cell-specific essential genes from the gene expression signature by identifying the set of genes that are highly expressed resulted in inferior performance (FIG. 4d).

Predicting Individual Cell Line Drug Response

To study the potential utility of the invention in guiding personalized medicine therapeutic decisions, the HapMap and NCI-60 PRIME models were used to predict the response of each individual cell-line to various metabolic drugs, and compared the predicted response with the response measured in vitro^{31, 36-39} (Tables 2, 3, and 4). Overall, the analysis was predictive for 12 out of 16 drugs tested in the HapMap and the NCI-60 datasets (FIG. 4a; empiric P-value <9.9e-4). Applying a partial correlation analysis between in silico predicted and measured drug responses while controlling for the experimentally measured growth rate (as growth rate itself has been implicated as a predictor of drug response, e.g., for cytotoxic drugs), a significant association was still found between predicted and measured drug response for the HapMap and CEU datasets, and in some cases the correlation was even higher than before (Tables 2 and 3). These results demonstrate that utilizing a specifically-tailored metabolic model for predicting metabolic drugs response has a clear advantage over utilizing the raw data alone.

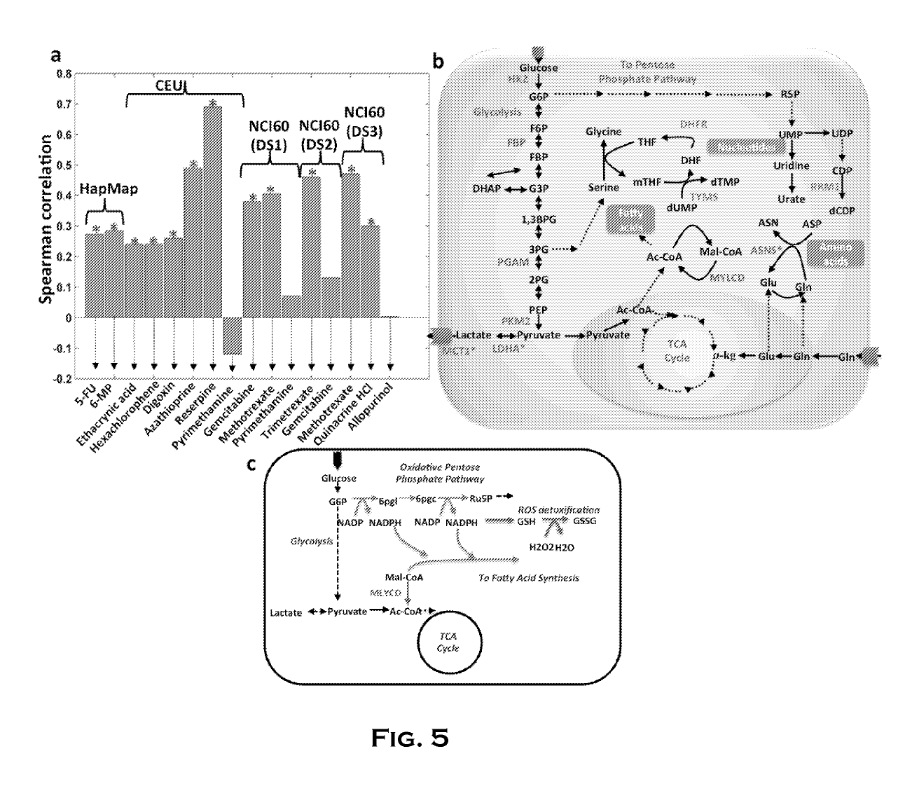

FIG. 5a. shows a comparison between the measured and predicted drug response for the HapMap, CEU (Western European ancestry) and NCI-60 datasets. Overall, significant correlations (Spearman P-value <0.05) were obtained for 12 out of the 16 drugs examined (those marked with an asterisk). The HapMap drugs are 5-fluorouracil (5FU) and 6-mercaptopurine (6MP); the CEU drugs are Ethacrynic acid, Hexachlorophene, Digoxin, Azathioprine, Reserpine and Pyrimethamine; The NCI-60 drugs for dataset 1 include Gemcitabine, Methotrexate and Pyrimethamine; For dataset 2, Trimetrexate and Gemcitabine; For dataset 3, Methotrexate, Quinacrine HCl and Allopurinol. FIG. 5b shows core metabolic pathways and metabolic enzymes that carry known and/or predicted cancer therapeutic targets. Metabolic enzymes colored green are a subset of known cytostatic drug targets. Metabolic enzymes colored red are those found in current clinical trials (and thus likely to be more selective than traditional cytotoxic drugs), out of which those marked by an asterisk were identified as selective targets in our simulations as well. Metabolic enzymes colored blue denote novel selective predictions according to our simulations. αKG, α-ketoglutarate; Ac-CoA, acetyl CoA; ASN, aspargine; ASNS, asparagine synthetase; ASP, aspartate; 1,3BPG, 1,3 biphosphoglyxerate; DHF, dehydrofolate; DHFR, dehydrofolate reductase; CDP, cytosine diphosphate; dCDP, deoxycytosine diphosphate; DHAP, dehydroxyacetone phosphate; dTMP, deoxythymidine monophosphate; dUMP, deoxyuridine monophosphate; F6P, fructose-6-phosphate; FBP, fructose-1,6-bisphosphate; G3P, glyceraldehydes 3-phospate; G6P, glucose-6-phosphate; Gln, glutamine; Glu, glutamate; HK2, hexokinase 2; LDHA, lactate dehydrogenase A; Mal-CoA, malonyl coa; MCT1, monocarboxylate transporter 1,4; mTHF, 5,10-Methylenetetrahydrofolate; MYLCD, malonyl-CoA decarboxylase; 2PG, glycerate 2-phosphate; 3PG, glycerate 3-phosphate; PEP, phosphoenolpyruvate; PGAM, phosphoglycerate mutase; PKM2, pyruvate kinase M2 isoform; RSP, ribose-5-phosphate; RRM1, ribonucleotide reductase M1; SHMT1, serine hydroxymethyltransferase 1; TCA, tricarboxylic acid; THF, tetrahydrofolate; TYMS, thymidylate synthase; UDP, uridine diphophate; UMP, uridine monophosphate; UPP1, uridine phosphorylase. FIG. 5c shows a schematic description of metabolic changes following Malonyl-CoA Decarboxylase (MLYCD) knockdown. MLYCD suppression is predicted to divert the accumulated malonyl-CoA to fatty acid biosynthesis, increasing the demand of cells for reducing power. The latter is generated by the oxidative branch of the pentose phosphate pathway, leading to an overall increase in oxidative stress. Green/red arrows represent increased/decreased flux, respectively.

Predicting Cancer Drug Targets with a Selective Effect on Cell Proliferation

The array of models built for both normal (HapMap) and cancer (NCI-60) proliferating cells allows searching for selective drug targets, i.e., those that would kill cancer cells without disrupting the proliferation of normal cells. This approach differs from most of the existing cytotoxic strategies, which affect both normal and cancer cells. All knockdowns of individual reactions in the normal lymphoblasts and cancer cell models were simulated, and their selective effect on the proliferation of cancerous versus normal cells was quantified. Of interest are potential drug targets affecting both normal and cancer cell proliferation (non-selective) and those affecting mainly cancer cell proliferation (selective).

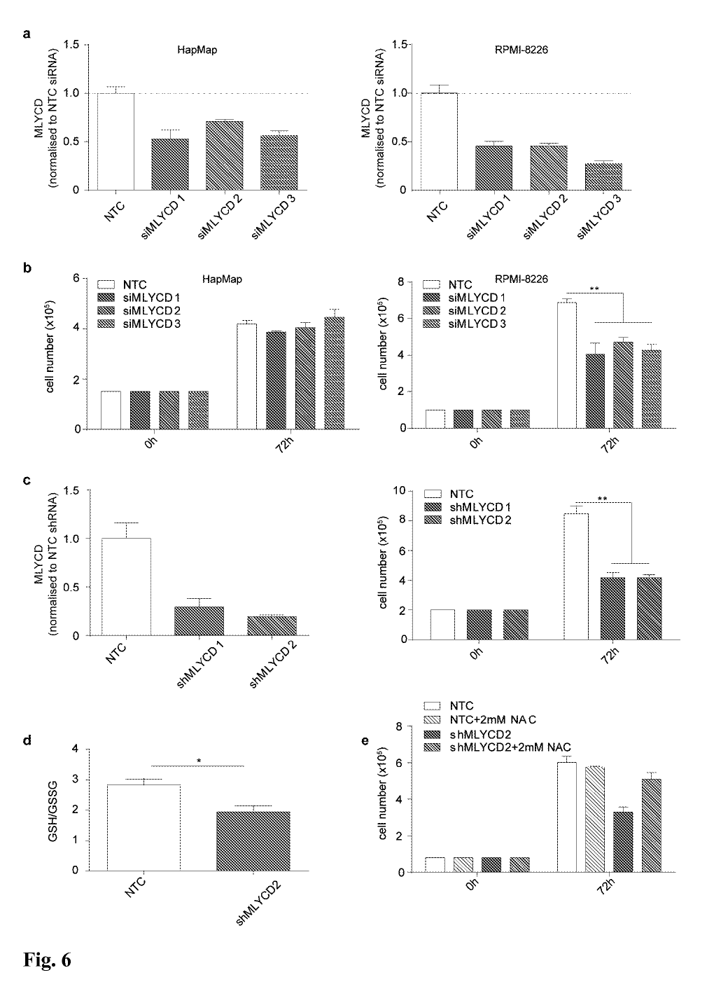

The set of predicted non-selective targets was highly enriched with known cytostatic drugs^{23, 40} (mean hypergeometric P-value=7.28e-4, FIG. 5b, Table 5). The predicted selective targets were also enriched with targets of newly developed drugs (FIG. 3b): Out of the 5 metabolic enzyme drug targets that have been reported⁴¹, the analysis identified 3 as being selective (hypergeometric P-value=3.98e-4, .Table. 6). The clinical relevance of the predicted selective targets was examined by analyzing a cohort of 1,586 breast cancer patients⁴². This set was found to be enriched (Hypergeometric P-value=1e-2) with genes whose lower expression is significantly associated with improved survival (log rank P-value <0.05, FDR with α=0.05, Methods). Moreover, this result was found to be significant (Hypergeometric P-value=1.3e-2) independent of known prognostic variables such as the patient's clinical stage, histological grade, tumor size, lymph node status and estrogen receptor status, as estimated by a Cox multivariate analysis. A similar analysis for the set of predicted non-selective targets yielded either borderline or insignificant results (.Table. 5). The analysis also yielded a set of novel predicted selective targets, including Malonyl-CoA Decarboxylase (MLYCD). MLYCD was ranked third in the prediction list (Table 6) and the first one catalyzed by a single enzyme. MLYCD is an important checkpoint for fatty acid metabolism that catalyzes the breakdown of malonyl-CoA to acetyl-CoA and carbon dioxide (FIG. 6c), and its predicted selective effect was tested experimentally as follows.

### A Comparative Experimental Study of MLYCD Silencing in Cancer Versus Normal Proliferating Cells

The prediction that cancer cells are selectively sensitive to MLYCD inhibition was tested experimentally. MLYCD was suppressed in the NCI-60 leukemia cell-line RPMI-8226 and in the control lymphoblast HapMap cell-line using small interfering RNA (siRNA) (FIG. 6a). Leukemia cells were chosen for this analysis as they are the only hematological tumor type found in the NCI-60 dataset. The effects of MLYCD suppression on cell proliferation was studied. As predicted, the silencing of MLYCD significantly inhibited the proliferation of RPMI-8226 cells but had no effect on HapMap cells (FIG. 6b). The selective effect of MLYCD suppression on cell proliferation was confirmed using another leukemia cell-line from the NCI-60 database—the K562 cells (FIG. 8). Importantly, the anti-proliferative effects of MLYCD suppression could not be explained by different expression of the enzyme among the different cell-lines (FIG. 8). In order to further investigate the mechanism of growth inhibition caused by the silencing of MLYCD, RPMI-8226 cells that stably express a doxycycline-inducible short hairpin RNA (shRNA) targeting MLYCD were generated, where the incubation with doxycycline resulted in a significant and stable suppression of MLYCD (FIG. 6e). In line with the siRNA experiments, cell proliferation was significantly inhibited in MLYCD-deficient cells (FIG. 6e). Importantly, the functional inactivation of MLYCD resulted in a substantial decrease of acyl-carnitines, consistent with the expected inhibition of carnitine-palmitoyl transferase (CPT) by Malonyl-Coa (McGarry et al.⁴³ FIG. 8).

The embodiment was then used to investigate the “metabolic rewiring” that occurs upon MLYCD inactivation. The model predicted that MLYCD suppression would divert the accumulated malonyl-CoA to fatty acid biosynthesis, increasing the demand of cells for reducing power (FIG. 5c and Table 7). It was hypothesized that MLYCD suppression would divert reducing power to aberrant fatty acid biosynthesis, thereby leading to increased oxidative stress. In line with this hypothesis, it was found that MLYCD-deficient cells have a significantly lower GSH/GSSG ratio (FIG. 5d). More importantly, the incubation of cells with the antioxidant N-Acetyl-cysteine restored the proliferative defects caused by the loss of MLYCD (FIG. 6e), suggesting that the effects of MLYCD suppression depends, at least in part, on increased oxidative stress.

FIG. 6a shows MLYCD mRNA expression upon nucleofection with Non Targeting Control (NTC) and three independent siRNA constructs in HapMap (left) and RPMI-8226 (right) cells. FIG. 6b shows cell proliferation of HapMap (left) and RPMI-8226 (right) cells upon MLYCD knockdown (siRNA). FIG. 6c shows MLYCD mRNA expression upon infection with Non Targeting Control (NTC) and two independent shRNA constructs in RPMI-8226 cells. FIG. 6d shows the ratio between reduced (GSH) and oxidized (GSSG) glutathione in RPMI-8226 cells infected with the indicated constructs. FIG. 6e shows cell proliferation of the indicated cell-lines in the presence or absence of 2 mM N-Acetyl Cysteine. The data in FIG. 6 are shown as mean±sem and were obtained from at least 3 independent experiments. * P-value <0.05; ** P-value <0.01.

Reconstructing Personalized Metabolic Models of Breast Cancer Clinical Samples and Predicting their Survival

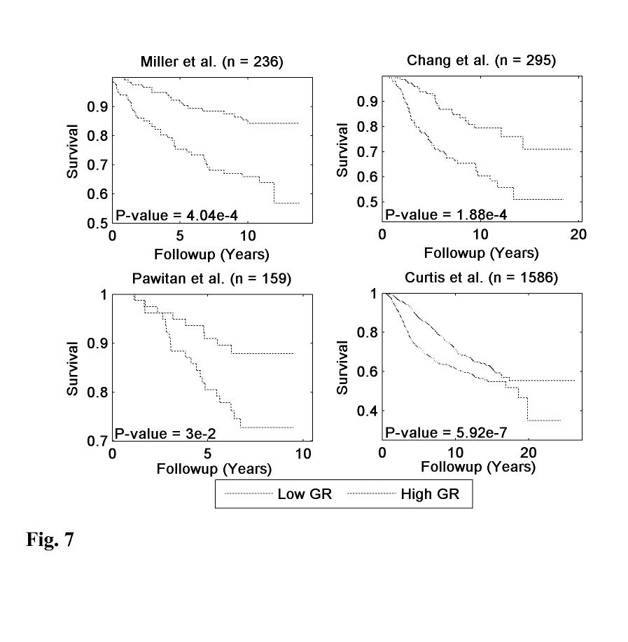

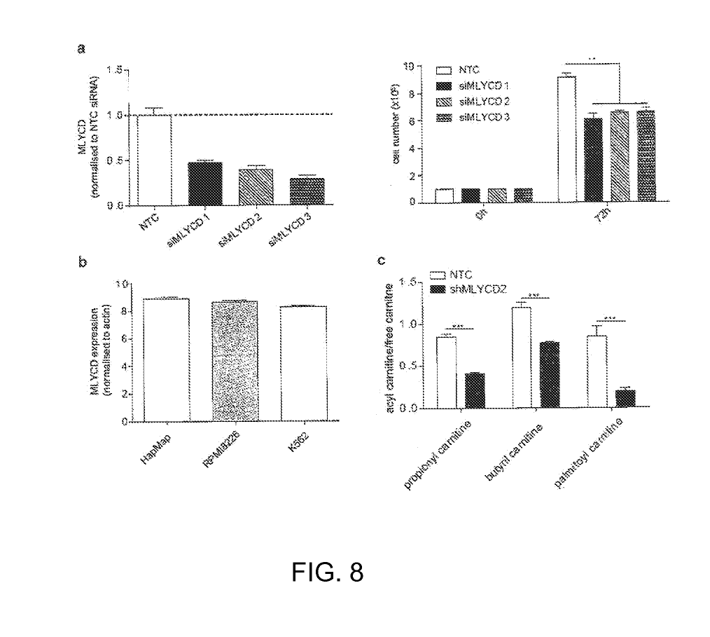

The ability of the model to predict a patient's prognosis based on their biopsy samples was also examined. To this end, gene expression data of tumor biopsies taken from four cohorts of breast cancer patients was utilized. This type of cancer cell was used due to the large availability of clinical data that is associated with the gene expression of each sample, including more than 2000 breast cancer patients⁴⁴⁻⁴⁶. The model was applied to reconstruct personalized metabolic models for each individual sample and to assess its maximal growth rate. A Kaplan-Meier survival analysis⁴⁷ showed that patients with predicted high growth rate had significantly improved survival than those with a predicted low growth rate, in all four cohorts (log rank P-values are: 4.04e-4, 1.88e-4, 0.03 and 5.92e-7 for Miller et al., Chang et al., Pawitan et al. and Curtis et al. respectively, FIG. 7). Furthermore, a Cox univariate and multivariate survival analyses⁴⁸ showed that the predicted growth rate is a good prognostic marker independent of the patient's age, clinical stage, histological grade, tumor size, lymph node status and estrogen receptor status (P-values are: 7.89e-4, 1.19e-5, 0.02 and 0.02 for Miller et al., Chang et al., Pawitan et al. and Curtis et al. respectively, Table 8), all known clinical predictors of breast cancer survival^{49, 50}. Taken together, these results show that a central metabolic feature generated by personalized metabolic models (the maximal growth rates) is capable of predicting patient prognosis from raw clinical data. Repeating the Kaplan-Meier analysis by using a multiple linear regression analysis to estimate the sample growth rates directly from the gene expression data in a model independent manner resulted in markedly inferior survival predictions, testifying to the value of personalized GSMMs.

The finding that high growth rate is a good prognostic sign may seem counter-intuitive at first. However, two key factors may explain this apparent contradiction:

(1) This finding is in accordance with the prevailing notion that proliferating cells tend to better respond to chemotherapy⁵¹⁻⁵³. Indeed, when performing this analysis separately for chemotherapy-treated and non-treated patients, it was found that the association between growth rate and favored prognosis is more prominent in the treated group (Curtis et al., log rank P-values: 0.01 and 0.07 for treated versus non-treated patients, respectively; Chang et al., log rank P-values: 1e-3 and 0.02 for treated versus non-treated patients, respectively). Moreover, applying the invention to reconstruct metabolic models of chemo-sensitive and chemo-resistant cancer cells, we find that the former have a significantly higher predicted growth rate (one-sided Wilcoxon P-value=1.35e-4, FIG. 8).

(2) Another explanation that may underlie this apparent contradiction is the observation that high migratory cells such as late stage metastatic cancer cells tend to have lower growth rates⁵⁴, probably due to the diversion of energy resources from biomass production to other cellular tasks, such as motility and counteracting rising radical oxygen levels^{54, 55}. Indeed, it was found that higher stage tumors have significantly lower predicted growth rates in all four datasets (one-sided Wilcoxon P-value <0.05, Table 9). Combining these two observations together, it was examined to what extent the predicted growth rate is a prognostic marker when performing the analysis for each cancer stage separately and then considering treated versus non-treated patients⁴². It was found that the association between predicted growth rates and better survival only holds for the treated patients in each stage (log rank P-value <0.05, Table 10). These results suggest that it is likely that both explanations may underlie the observed association, with drug responsiveness possibly playing a larger role.

FIG. 7 shows a Kaplan-Meier survival analysis for the 4 breast cancer datasets analyzed here (Miller et al., Chang et al., Pawitan et al. and Curtis et al.). In all four cohorts the analysis showed that patients with predicted high growth rate (GR) had significantly improved survival compared to those with predicted low growth rate (GR).

Methods

Drug Response Simulations

Each drug is mapped to its corresponding metabolic reaction through its known enzymatic targets according to the DrugBank database⁴⁰. The drug response data used in this analysis was measured in various ways:

(a) ATP concentrations (HapMap dataset). In this case the in silico drug response was computed in two steps. Firstly, a wild-type flux distribution was obtained via Flux Balance Analysis, in which the corresponding drug target reaction is initially forced to be active in the pre-drug condition. Enforcing the target reaction to be active is necessary in order to get any effect on the resulting flux distribution, following inhibition of the target reaction, to be simulated in the next step. Here a positive flux was enforced through the target reactions that is 50% of the maximal flux rate it is capable of carrying (the results are robust to various activation thresholds. (2) Next, the knockout flux distribution is computed via MOMA (Minimization Of Metabolic Adjustment)⁵⁶ while constraining the flux through the corresponding reactions to zero. This process is repeated for each personalized model separately and the predicted ATP production is used to estimate the cell response to the simulated drug. A robustness analysis is carried out by using 1000 different wild-type flux distributions.

(b) AC50 values (CEU dataset); AC50 values represent the concentration in which the drug exhibits 50% of its maximum efficacy. In this case, in silico AC50 values are calculated by estimating the maximal flux rate carried by the target reaction when the growth rate is set to 50% of the drug's maximal response (a value that was available in the dataset used³⁶).

(c) IC50 values (NCI-60 dataset); IC50 values represent the concentration of drug needed in order to reduce the growth to 50% of its maximal value. In this case, in silico IC50 values are calculated by estimating the maximal flux rate carried by the target reaction when the growth rate is set to 50% of its maximal value. In all cases of drug response simulations, the empirical significance test is carried out by permuting the measured data 1000 times and estimating the resulting correlation for each permuted vector.

Gene Essentiality Analysis

The effect of reaction deletion on cell proliferation was simulated in a similar manner to that described above in reference to the drug response simulation (part a) with the difference of optimizing for maximal growth rate rather than ATP production and the induction of partial knockouts (i.e., reducing reaction flux level to 10-30% of its maximal flux).

In order to compare the model predictions to the experimental shRNA scores provided per gene, each reaction is assigned the minimal shRNA score of its catalyzing enzymes. Both experimental and predicted data are represented as the log-transformed fold-change in the cell growth. A hyper-geometric test is then applied in order to determine whether there is a significant overlap between experimental and predicted growth reducing genes. For evaluating the performance of the generic model, the model's single set of predicted growth reducing genes is compared with the experimentally determined growth reducing genes in each cell-line considered alone. The predictive value of the personalized models generated is then evaluated by extending the set of growth-reducing genes identified by the generic model with additional specific growth-reducing genes identified by the corresponding generated personalized model, comparing them again to the experimentally determined growth reducing genes in each of the cell-lines. In order to evaluate the predictive power of the gene expression alone, whether or not there is a significant overlap between growth reducing genes and highly expressed genes was examined. In this regard, highly expressed genes are defined as the set of genes whose expression is higher than the mean+half the standard deviation of the expression of the genes in each cell-line. Defining the set of essential genes in each dataset is threshold dependent. The results were obtained by comparing the set of genes that reduce growth rate by at least 25%. Examining alternative thresholds between 10-60%, the invention was found to enhance the prediction of the generic model for 40-80% of the cell-lines.

Drug Selectivity Analysis

The effect of a reaction's deletion on cell proliferation for the identification of selective treatment was simulated in a similar manner to that described above in reference to gene essentiality. The overlap between the set of known cytostatic drug targets and those predicted, was found to be robust to different thresholds that determine the value (in percentage) under which the deletion is considered to effect the cell's proliferation rate (Table 5). The set of selective reaction targets is composed of those that reduce the growth of all normal cells by less than 20% and the growth of all cancer cells by more than 20%. Additionally, this set includes only those reactions that exhibit more than a 20% difference in growth reduction between the normal and cancer proliferating cells (Table 6). The enrichment of selective and non-selective targets within genes whose low expression is associated with an improved survival was calculated by assigning each reaction the minimal log rank p-value of its catalyzing enzymes. The log rank p-values were determined by a Kaplan-Meier survival analysis performed for each gene separately. A hyper-geometric test was then applied to determine the significance level of this analysis.

Constructing Personalized Metabolic Models for the Achilles Cell-Lines and Breast Cancer Patients

The set of growth-associated reactions identified in the NCI-60 dataset was utilized as input in the construction process of both the Achilles cell-line models and of the breast cancer patients' models. The method then proceeds by adjusting the bounds of this set of reactions according to the specific cell expression levels.

The Achilles dataset contains many samples having the exact same growth rate (only 15 unique growth rate values for 99 cell-lines). Therefore, the correlation between these measured values and the predicted growth rates is obtained by aggregating all cell-lines having the same growth rate, and comparing these unique values to the averaged predicted growth rates of the corresponding cell-lines.

Experimental Procedures

Cell Culture

HapMap cells (GM06997, CEPH/UTAH pedigree 13291) were obtained from Coriell Institute and RPMI-8226 and K562 cells were obtained from NCI-Frederick Cancer DCTD Tumor/Cell line Repository. Cells were grown in RPMI 1640 plus 10% fetal bovine serum (FBS) in the presence of 5% carbon dioxide. Cell count was determined using a CASY Cell Counter (Roche Applied Science). Where indicated, cells were incubated with 2 mM N-acetyl-cysteine.

MLYCD Silencing

siRNA

2×10⁶ Cells were nucleofected using Nucleofector I (Amaxa) and Amaxa Cell Line Nucleofector Solution Kit C (Lonza), program A-030 and 1 μM siRNA. The MLYCD-targeting siRNA constructs were purchased from Sigma Aldrich and are as follows:

| | |
|---|---|
| siRNA1: GUACCUACAUCUUCAGGAA; | (SEQ ID NO 1) |
| siRNA2: CAAAGUUGACUGUGUUCUU; | (SEQ ID NO 2) |
| siRNA3: GAAGGAACAUCCUCCAUCA. | (SEQ ID NO 3) |

The non-targeting siRNA is the MISSION siRNA Universal Negative Control #1 (Sigma Aldrich).

shRNA

The viral supernatant for infection was obtained from the filtered growth media of the packaging cells HEK293T transfected with 3 μg psPAX, 1 μg pVSVG, 4 μg of shRNA contructs and 24 μl Lipofectamine 2000 (Life Technology) and the relevant shRNAs. 5×10⁵ cells were then plated on 6-well plates and infected with the viral supernatant in the presence of 4 μg/mL polybrene. After two days, the medium was replaced with selection medium containing 2 μg/mL puromycin.

The expression of the shRNA constructs was induced by incubating cells with 2 μg/mL Doxycyclin.

The shRNA sequences were purchased from Thermoscientific and were as follows:

| | |
|---|---|
| shRNA1: TTCTGAAGCACTTCACACG; | (SEQ ID NO 4) |
| shRNA2: GATTTTGTTCTTCTCTTCT;. | (SEQ ID NO 5) |
| shRNA NTC # RHS4743 | |

Glutathione Measurements

Glutathione levels were measured using the GSH-Glo Glutathione Assay (Promega) after 72 hours of Doxyclyclin induction, using 20 μL/well of 2×10⁵ cells/mL in accordance with the manufacturer's instructions.

qPCR Experiments.

mRNA was extracted with RNeasy Kit (Qiagen) and 1 μg of mRNA was retro-transcribed into cDNA using the High Capacity RNA-to-cDNA Kit (Applied Biosystems, Life Technologies, Paisley, UK).

For the qPCR reactions, 0.5 μM primers were used. 1 μL of Fast Sybr green gene expression master mix; 1 μL of each primer and 4 μL of 1:10 dilution of cDNA in a final volume of 20 μL were used. Real-time PCR was performed using the Step One Real-Time PCR System (Life Technologies Corporation Carlsbad, Calif.) using the fast Sybr green program. Expression levels of the indicated genes were calculated using the ΔΔCt method by the appropriate function of the software using actin as calibrator.

Primer sequences are as follows:

MLYCD: Fwd:

(SEQ ID NO 6)

ttgcacgtggcactgact;
RV:

(SEQ ID NO 7)

ggatgttccttcacgattgc;
Actin:
QuantiTect primer QT00095431 (Qiagen), sequence
not disclosed.

LC-MS Metabolomic Analysis.

For liquid chromatography separation, column A was the Sequant Zic-Hilic (150 mm×4.6 mm, internal diameter (i.d.) 5 μm) with a guard column (20 mm×2.1 mm i.d. 5 μm) from HiChrom, Reading, UK. Mobile phase A: 0.1% formic acid v/v in water. Mobile B: 0.1% formic acid v/v in acetonitrile. The flow rate was kept at 300 μL/min and the gradient was as follows: 0 minutes 80% of B, 12 minutes 50% of B, 26 minutes 50% of B, 28 minutes 20% of B, 36 minutes 20% of B, 37-45 minutes 80% of B. Column B was the sequant Zic-pHilic (150 mm×2.1 mm i.d. 5 μm) with the guard column (20 mm×2.1 mm i.d. 5 μm) from HiChrom, Reading, UK. Mobile phase C: 20 mM ammonium carbonate plus 0.1% ammonia hydroxide in water. Mobile phase D: acetonitrile. The flow rate was kept at 100 μL/minute and gradient as follow: 0 minutes 80% of D, 30 minutes 20% of D, 31 minutes 80% of D, 45 minutes 80% of D. The mass spectrometer (Thermo Q-Exactive Orbitrap) was operated in a polarity switching mode.

Metabolomic Extraction of Cell-Lines.

5×10⁵ cells/mL were plated onto 6-well plates and cultured in standard medium for 24 hours. For the intracellular metabolomic analysis, cells were quickly washed three times with phosphate buffer saline solution (PBS) to remove contamination from the media. The PBS was thoroughly aspirated and cells were lysed by adding a pre-cooled Extraction Solution (Methanol: Acetonitrile: Water 50:30:20). The cell number was counted and cells were lysed in 1 ml of Extraction Solution per 2×10⁶ cells. The cell lysates were vortexed for 5 minutes at 4° C. and immediately centrifuged at 16,000 g for 15 minutes at 0° C.

Datasets

Expression data and growth rate measurements for the HapMap dataset were taken from Choy et al.³¹. The data includes Utah residents with Northern and Western European ancestry (CEU; 56 samples), Han Chinese in Beijing, China (CHB; 43 samples), Japanese in Tokyo, Japan (JPT; 43 samples) and Yoruba from Ibadan, Nigeria (YRI; 82 samples). Expression data for the NCI-60 dataset was taken from Lee et al.³³. Doubling times for the NCI-60 cell lines were downloaded from the website of the Developmental Therapeutics Program (DTP) at NCI/NIH (http://dtp.nci.nih.gov/docs/misc/common_files/cell_list.html). Expression data and shRNA screen data for the Achilles cell-lines were downloaded from the Cancer Cell Line Encyclopedia and Achilles project websites.

### Constructing Personalized Metabolic Models of Lymphoblasts and Cancer Cell Lines

To control for the indirect usage of growth rate measurement in the application of the method of the invention, a 5-fold cross validation analysis was employed for the HapMap dataset and a 4-fold cross validation analysis for the NCI-60 dataset which was repeated 1000 times for each dataset. To further evaluate the significance of the results, an empirical test was conducted by comparing the results to those obtained by random sets of the HapMap or the NCI-60 models, generated by permuting the gene expression values 1000 times. For both datasets, the original results were found to be highly significant (empiric P-value <9e-4). An additional permutation test was conducted by choosing a random set of genes at the size of the growth-associated genes, and utilizing them in the personalized model building process. Repeating this procedure 1000 times for each dataset resulted again in highly significant results (empiric P-value <9e-4).

Correlation Results for the HapMap and NCI-60 Datasets when Modifying the Bounds on all Enzyme-Associated Reactions
HapMap—Spearman R=0.24 P-value=2.4e-4
NCI-60—Spearman R=0.56, P-value=2.8e-6

2. Personalized Metabolic Models Predict Individual Cell Lines' Drug Response

### The HapMap Dataset:

Drug response data used in this dataset is given as ATP concentration levels³¹. For each of the lymphoblast models and for each activation threshold (see Methods) the solution space was sampled and 1000 different flux distributions were obtained based on Bordel et al⁵⁷. The results shown in Table 2 are the mean Spearman R correlation between measured and predicted drug response obtained by utilizing each of the 1000 sampled flux distributions as the wild-type flux distribution. The partial correlation results, i.e., controlling for the measured growth rate, are also reported in Table 2.

TABLE 2
Drug response results (HapMap)

| | 5-fluorouracil (5FU) | | | | 6-mercaptopurine (6MP) | | | |
|---|---|---|---|---|---|---|---|---|
| | | | Spearman | | | | Spearman | |
| Activation | Spearman | | Partial | | Spearman | | Partial | |
| threshold | Correlation | P-value | Correlation | P-value | Correlation | P-value | Correlation | P-value |
| 10% | 0.19 | 0.0038 | 0.29 | 1.42e−05 | 0.17 | 0.03 | 0.25 | 0.0002 |
| 20% | 0.24 | 3.75e−4 | 0.32 | 1.59e−06 | 0.18 | 0.0078 | 0.28 | 3.63e−05 |
| 30% | 0.26 | 1.17e−4 | 0.33 | 9.33e−07 | 0.21 | 0.0019 | 0.29 | 1.26e−05 |
| 40% | 0.27 | 6.98e−5 | 0.32 | 1.88e−06 | 0.23 | 6e−4 | 0.3 | 7.95e−06 |
| 50% | 0.28 | 7.63e−5 | 0.3 | 5.33e−06 | 0.26 | 1.36e−4 | 0.31 | 3.48e−06 |
| 60% | 0.27 | 4.82e−5 | 0.3 | 5.81e−06 | 0.26 | 7.52e−5 | 0.3 | 5.83e−06 |
| 70% | 0.25 | 2.06e−4 | 0.26 | 6.96e−05 | 0.28 | 2.56e−5 | 0.3 | 4.87e−06 |
| 80% | 0.16 | 0.021 | 0.17 | 0.0119 | 0.27 | 6.32e−5 | 0.29 | 2.49e−05 |

### The CEU Dataset:

Drug response data used in this dataset is given as AC50 values³⁶. AC50 values represent the concentration in which the drug exhibits 50% of its maximum efficacy. In this case, in silico AC50 values were calculated by estimating the maximal flux rate carried by the target reaction when the growth rate is set to 50% of the drug's maximal response (a value that was available in the dataset used³⁶). The partial correlation results (i.e., controlling for the measured growth rate) are reported in Table 3.

TABLE 3
Drug response results (CEU)

| | | | Spearman | |
|---|---|---|---|---|
| | Spearman | P- | partial | P- |
| Drug Name | Correlation | value | Correlation | value |
| Ethacrynic acid | 0.24 | 0.05 | 0.26 | 0.04 |
| Hexachlorophene | 0.24 | 0.05 | 0.25 | 0.04 |
| Digoxin | 0.26 | 0.05 | 0.26 | 0.05 |
| Azathioprine | 0.49 | 4e−4 | 0.49 | 4e−4 |
| Reserpine | 0.69 | 4e−5 | 0.69 | 4e−5 |

### The NCI-60 Dataset:

Table 4 shows drug response data from this dataset, given as IC50 values³⁷⁻³⁹. IC50 values represent the concentration of drug needed in order to reduce the growth to 50% of its maximal value. In this case, in silico IC50 values are calculated by estimating the maximal flux rate carried by the target reaction when growth rate is set to 50% of its maximal value. The partial correlation results (i.e., controlling for the measured growth rate) in this case were insignificant (P-value >0.05).

TABLE 4
Drug response results (NCI-60)

| | Spearman | P- |
|---|---|---|
| Drug Name | Correlation | value |
| Gemcitabine 1 | 0.38 | 0.03 |
| Methotrexate 1 | 0.4 | 0.02 |
| Trimetrexate 2 | 0.45 | 2.3e−4 |
| Methotrexate - 3 | 0.47 | 1.18e−4 |
| Quinacrine HCl - 3 | 0.1 | 0.01 |

In cases where multiple reactions are associated with a drug's targets, the analysis was done for each reaction separately and the reported correlation is the mean over the correlation obtained for each reaction alone. In most cases similar correlations were obtained for different reactions targeted by the same drug. Two exceptions were the drugs Ethacrynic acid and Hexachlorophene in which a significant correlation of 0.24 was obtained for only one of the target reactions.

3. Personalized Metabolic Models Predict Drug Targets with a Selective Effect on Cell Proliferation

Enrichment Analysis of Currently Used Cytostatic Drugs:

The effect of a reaction's deletion on cell proliferation for the identification of selective treatment was simulated as described in the Methods section of this document. The overlap between the set of 24 cytostatic drug targets taken from Folger et al.²³ (drugs classified as “Metabolic Anticancer Drug Targets”), and the predictions were found to be robust to different thresholds that determine the value (in percentage) under which the deletion is considered to effect the cell's proliferation rate. Table 5 describes the enrichment found for different thresholds. The mean over these values is the one reported herein. Additionally, the hyper-geometric enrichment of the predicted non-selective targets within genes whose low expression is significantly associated with improved survival was examined. The enrichment results are also reported in Table 7.

TABLE 5

| Threshold | Hypergeometric | Hypergeometric |
|---|---|---|
| (% of reduction in | Enrichment | enrichment |
| maximal growth rate) | P-value | (survival analysis) |
| 10% | 4.05e−7 | 0.03 |
| 20% | 4.24e−4 | 0.14 |
| 30% | 0.0031 | 0.43 |
| 40% | 1.09e−4 | 0.34 |
| 50% | 1.07e−5 | 0.28 |

TABLE 6
List of selective drug targets:

| | | | | % of knockdown | % of knockdown |
|---|---|---|---|---|---|
| | | | | growth rate in | growth rate in |
| | | | | respect to the | respect to the |
| | Reaction | | Catalyzing | maximal wild-type | maximal wild-type |
| | Description | Reaction | Genes | growth rate | growth rate |
| Metabolic Pathway | (abbreviations) | Description | (Entrez ID) | (HapMap) | (NCI-60) |
| ‘Glutamate | ‘1pyr5c[m] + | ‘1-Pyrroline-5- | ‘(8659.1) | 0.892294835 | 0 |
| metabolism’ | 2h2o[m] + nad[m] => | carboxylate + 2H2O + | or (8659.2)’ | | |
| | glu_DASH_L[m] + | Nicotinamide adenine | | | |
| | h[m] + nadh[m]’ | dinucleotide => | | | |
| | | L-Glutamate + H+ + | | | |
| | | Nicotinamide adenine | | | |
| | | dinucleotide - reduced’ | | | |
| ‘Arginine | glu5sa[m] => | ‘L-Glutamate 5- | ‘(8659.1) | 0.90438625 | 0.02371005 |
| and Proline | 1pyr5c[m] + | semialdehyde <=> | or (8659.2)’ | | |
| Metabolism’ | h2o[m] + h[m]’ | 1-Pyrroline-5- | | | |
| | | carboxylate + H2O + H+’ | | | |
| ‘Fatty Acid | ‘h[c] + malcoa[c] => | ‘H+ + Malonyl- | ‘(23417.1)’ | 0.909120836 | 0.038396098 |
| Metabolism’ | accoa[c] + co2[c]’ | CoA => Acetyl-CoA + CO2’ | | | |
| ‘Transport, | ‘acrn[c] => acrn[m]’ | ‘O-Acetylcarnitine => | ‘(788.1)’ | 0.914954431 | 0.062296965 |
| Mitochondrial’ | | O-Acetylcarnitine’ | | | |
| ‘Fatty Acid | acrn[m] + coa[m] => | ‘O-Acetylcarnitine + | ‘(1384.1)’ | 0.914991097 | 0.06242108 |
| Metabolism’ | accoa[m] + crn[m]’ | Coenzyme A <=> Acetyl-CoA + | | | |
| | | L-Carnitine’ | | | |
| ‘Carnitine | accoa[c] + crn[c] => | ‘Acetyl-CoA + | ″ | 0.917587661 | 0.072811894 |
| shuttle’ | acrn[c] + coa[c]’ | L-Carnitine <=> | | | |
| | | O-Acetylcarnitine + | | | |
| | | Coenzyme A’ | | | |
| ‘Pentose and | h[c] + nadph[c] + | ‘H+ + Nicotinamide | ‘(51181.1)’ | 0.959288129 | 0.131866174 |
| Glucuronate | xylu_DASH_L[c] => | adenine dinucleotide | | | |
| Interconversions' | nadp[c] + xylt[c]’ | phosphate - reduced + | | | |
| | | L-Xylulose <=> Nicotinamide | | | |
| | | adenine dinucleotide | | | |
| | | phosphate + Xylitol’ | | | |
| ‘Pentose and | nad[c] + xylt[c] => | ‘Nicotinamide | ″ | 0.869006337 | 0.055786672 |
| Glucuronate | h[c] + nadh[c] + | adenine dinucleotide + | | | |
| Interconversions’ | xylu_DASH_D[c]’ | Xylitol <=> H+ + | | | |
| | | Nicotinamide adenine | | | |
| | | dinucleotide - reduced + | | | |
| | | D-Xylulose’ | | | |
| ‘Inositol | ‘g6p[c] => | ‘D-Glucose 6-phosphate => | ‘(51477.1)’ | 0.945646067 | 0.143291355 |
| Phosphate | mi1p_DASH_D[c]’ | 1D-myo-Inositol 1-phosphate’ | | | |
| Metabolism’ | | | | | |
| ‘Transport, | h[c] + pi[c] => | ‘H+ + Phosphate <=> | ‘(5250.4) | 0.947729366 | 0.155260367 |
| Mitochondrial’ | h[m] + pi[m]’ | H+ + Phosphate’ | or (5250.1) | | |
| | | | or (5250.3) | | |
| | | | or (5250.2)’ | | |
| ‘Glycolysis/ | ‘fad[m] + glyc3p[c] => | ‘Flavin adenine | ‘(2820.1)’ | 0.93347498 | 0.168054901 |
| Gluconeogenesis’ | dhap[c] + fadh2[m]’ | dinucleotide oxidized + | | | |
| | | Glycerol 3-phosphate => | | | |
| | | Dihydroxyacetone phosphate + | | | |
| | | Flavin adenine dinucleotide | | | |
| | | reduced’ | | | |
| ‘Inositol | ‘ h2o[c] + | ‘H2O + 1D-myo-Inositol | ‘(3612.1) | 0.95979832 | 0.194387708 |
| Phosphate | mi1p_DASH_D[c] => | 1-phosphate => myo- | or (3613.1)’ | | |
| Metabolism’ | inost[c] + pi[c]’ | Inositol + Phosphate’ | | | |
| ‘Transport, | ‘crn[m] => crn[c]’ | ‘L-Carnitine => | ‘(788.1)’ | 0.952892303 | 0.193124071 |
| Mitochondrial’ | | L-Carnitine’ | | | |
| ‘Pyruvate | lac_DASH_L[m] + | ‘L-Lactate + Nicotinamide | ‘(3939.1)’ | 0.801184314 | 0.195065418 |
| Metabolism’ | nad[m] => | adenine dinucleotide <=> H+ + | | | |
| | h[m] + nadh[m] + | Nicotinamide adenine | | | |
| | pyr[m]’ | dinucleotide - reduced + | | | |
| | | Pyruvate’ | | | |
| ‘Glyoxylate and | ‘h[c] + hpyr[c] => | ‘H+ + | ″ | 0.840924614 | 0.309829501 |
| Dicarboxylate | co2[c] + gcald[c]’ | Hydroxypyruvate => CO2 + | | | |
| Metabolism’ | | Glycolaldehyde’ | | | |
| ‘Glyoxylate and | ‘gcald[c] + h2o[c] + | ‘Glycolaldehyde + | ‘(218.1) | 0.811239297 | 0.285562725 |
| Dicarboxylate | nad[c] => glyclt[c] + | H2O + Nicotinamide | or (223.1) | | |
| Metabolism’ | 2h[c] + nadh[c]’ | adenine dinucleotide => | or (8854.2) | | |
| | | Glycolate + 2H+ + | or (224.1) | | |
| | | Nicotinamide adenine | or (222.1) | | |
| | | dinucleotide - reduced’ | or (8854.1) | | |
| | | | or (221.1) | | |
| | | | or (216.1) | | |
| | | | or (8854.3) | | |
| | | | or (501.1) | | |
| | | | or (220.1)’ | | |
| ‘Pentose and | ‘atp[c] + | ‘ATP + D-Xylulose => | ‘(9942.1)’ | 0.888509313 | 0.499701014 |
| Glucuronate | xylu_DASH_D[c] => | ADP + H+ + D-Xylulose | | | |
| Interconversions’ | adp[c] + h[c] + | 5-phosphate’ | | | |
| | xu5p_DASH_D[c]’ | | | | |
| ‘Glycolysis/ | fdp[c] + h2o[c] => | ‘D-Fructose 1,6- | ‘(2203.1) | 0.887367653 | 0.552495534 |
| Gluconeogenesis’ | f6p[c] + pi[c]’ | bisphosphate + H2O => | or (8789.1)’ | | |
| | | D-Fructose 6-phosphate + | | | |
| | | Phosphate’ | | | |
| ‘Alanine and | ‘asp_DASH_L[c] + | ‘L-Aspartate + | ‘(440.1) | 0.86846644 | 0.555360789 |
| Aspartate | atp[c] + gln_DASH_L[c] + | ATP + L-Glutamine + | or (440.3) | | |
| Metabolism’ | h2o[c] => amp[c] + | H2O => AMP + L-Asparagine + | or (440.2)’ | | |
| | asn_DASH_L[c] + | L-Glutamate + H+ + Diphosphate’ | | | |
| | glu_DASH_L[c] + h[c] + | | | | |
| | ppi[c]’ | | | | |
| Secretion | gluala[e] =>’ | ‘5-L-Glutamyl-L- | ‘(440.1) | 0.882465783 | 0.573342426 |
| | | alanine <=>’ | or (440.3) | | |
| | | | or (440.2)’ | | |
| ‘Transport, | gly[c] => gly[x]’ | ‘Glycine <=> Glycine’ | ‘(440.1) | 0.842540059 | 0.560186083 |
| Peroxisomal’ | | | or (440.3) | | |
| | | | or (440.2)’ | | |
| ‘Glyoxylate and | ‘h[c] + hpyr[c] + | ‘H+ + Hydroxypyruvate + | ‘(92483.1) | 0.818933702 | 0.537921091 |
| Dicarboxylate | nadh[c] => | Nicotinamide adenine | or (3948.2) | | |
| Metabolism’ | glyc_DASH_S[c] + nad[c]’ | dinucleotide - reduced => | or (160287.1) | | |
| | | (S)-Glycerate + | or (3945.1 | | |
| | | Nicotinamide adenine | and 3939.1) | | |
| | | dinucleotide’ | or (197257.2) | | |
| | | | or (3939.1) | | |
| | | | or (197257.1) | | |
| | | | or (3948.1) | | |
| | | | or (3945.1)’ | | |
| Secretion | glyc_DASH_S[e] =>’ | ‘(S)-Glycerate <=>’ | ‘(92483.1) | 0.818961883 | 0.53828551 |
| | | | or (3948.2) | | |
| | | | or (160287.1) | | |
| | | | or (3945.1 | | |
| | | | and 3939.1) | | |
| | | | or (197257.2) | | |
| | | | or (3939.1) | | |
| | | | or (197257.1) | | |
| | | | or (3948.1) | | |
| | | | or (3945.1)’ | | |
| ‘Transport, | ‘glyc_DASH_S[c] => | ‘(S)-Glycerate => | ‘(92483.1) | 0.818902909 | 0.538441582 |
| Extracellular’ | glyc_DASH_S[e]’ | (S)-Glycerate’ | or (3948.2) | | |
| | | | or (160287.1) | | |
| | | | or (3945.1 | | |
| | | | and 3939.1) | | |
| | | | or (197257.2) | | |
| | | | or (3939.1) | | |
| | | | or (197257.1) | | |
| | | | or (3948.1) | | |
| | | | or (3945.1)’ | | |
| Secretion | lac_DASH_D[e] =>’ | ‘D-Lactate <=>’ | ‘(92483.1) | 0.95450988 | 0.712972928 |
| | | | or (3948.2) | | |
| | | | or (160287.1) | | |
| | | | or (3945.1 | | |
| | | | and 3939.1) | | |
| | | | or (197257.2) | | |
| | | | or (3939.1) | | |
| | | | or (197257.1) | | |
| | | | or (3948.1) | | |
| | | | or (3945.1)’ | | |
| Secretion | ‘ser_DASH_L[c] =>’ | ‘L-Serine =>’ | ‘(92483.1) | 0.932555997 | 0.693498573 |
| | | | or (3948.2) | | |
| | | | or (160287.1) | | |
| | | | or (3945.1 | | |
| | | | and 3939.1) | | |
| | | | or (197257.2) | | |
| | | | or (3939.1) | | |
| | | | or (197257.1) | | |
| | | | or (3948.1) | | |
| | | | or (3945.1)’ | | |
| Secretion | pyr[e] =>’ | ‘Pyruvate <=>’ | ‘(92483.1) | 0.950872143 | 0.714625475 |
| | | | or (3948.2) | | |
| | | | or (160287.1) | | |
| | | | or (3945.1 | | |
| | | | and 3939.1) | | |
| | | | or (197257.2) | | |
| | | | or (3939.1) | | |
| | | | or (197257.1) | | |
| | | | or (3948.1) | | |
| | | | or (3945.1)’ | | |
| ‘Glycolysis/ | lac_DASH_L[c] + | ‘L-Lactate + Nicotinamide | ‘(3945.1 | 0.914086569 | 0.681131057 |
| Gluconeogenesis’ | nad[c] => | adenine dinucleotide <=> | and 3939.1) | | |
| | h[c] + nadh[c] + | H+ + Nicotinamide | or (160287.1) | | |
| | pyr[c]’ | adenine dinucleotide - reduced + | or (3948.2) | | |
| | | Pyruvate’ | or (3939.1) | | |
| | | | or (3948.1) | | |
| | | | or (55293.1) | | |
| | | | or (3945.1) | | |
| | | | or (92483.1)’ | | |
| Secretion | acetone[e] =>’ | ‘Acetone <=>’ | ‘(3945.1 | 0.908178661 | 0.678046956 |
| | | | and 3939.1) | | |
| | | | or (160287.1) | | |
| | | | or (3948.2) | | |
| | | | or (3939.1) | | |
| | | | or (3948.1) | | |
| | | | or (55293.1) | | |
| | | | or (3945.1) | | |
| | | | or (92483.1)’ | | |
| Secretion | ser_DASH_L[e] =>’ | ‘L-Serine <=>’ | ‘(3945.1 | 0.936833823 | 0.72301935 |
| | | | and 3939.1) | | |
| | | | or (160287.1) | | |
| | | | or (3948.2) | | |
| | | | or (3939.1) | | |
| | | | or (3948.1) | | |
| | | | or (55293.1) | | |
| | | | or (3945.1) | | |
| | | | or (92483.1)’ | | |
| ‘Glyoxylate and | ‘atp[c] + | ‘ATP + D-Xylulose => | ‘(3795.1) | 0.814011473 | 0.602521883 |
| Dicarboxylate | xylu_DASH_D[c] => | ADP + H+ + D-Xylulose | or (3795.2)’ | | |
| Metabolism’ | adp[c] + h[c] + | 1-phosphate’ | | | |
| | xu1p_DASH_D[c]’ | | | | |
| ‘Glyoxylate and | xu1p_DASH_D[c] => | ‘D-Xylulose 1-phosphate <=> | ‘(226.2) | 0.813885287 | 0.602824782 |
| Dicarboxylate | dhap[c] + gcald[c]’ | Dihydroxyacetone phosphate + | or (229.1) | | |
| Metabolism’ | | Glycolaldehyde’ | or (226.3) | | |
| | | | or (230.1) | | |
| | | | or (226.1)’ | | |
| ‘Transport, | ‘lac_DASH_L[c] => | ‘L-Lactate => | ‘(366.1)’ | 0.913709546 | 0.704292434 |
| Mitochondrial’ | lac_DASH_L[m]’ | L-Lactate’ | | | |
| Secretion | xylt[e] =>’ | ‘Xylitol <=>’ | ″ | 0.936491524 | 0.732867811 |
| ‘Glutathione | ‘cgly[e] + h2o[e] => | ‘Cys-Gly + H2O => | ‘(290.1)’ | 0.894294357 | 0.696228015 |
| Metabolism’ | cys_DASH_L[e] + gly[e]’ | L-Cysteine + Glycine’ | | | |
| ‘Glyoxylate and | ‘glx[c] + h2o[c] + | ‘Glyoxylate + H2O + | ‘(3939.1) | 0.807878238 | 0.688052568 |
| Dicarboxylate | nad[c] => 2h[c] + | Nicotinamide adenine | or (55293.1) | | |
| Metabolism’ | nadh[c] + oxa[c]’ | dinucleotide => 2H+ + | or (3945.1 | | |
| | | Nicotinamide adenine | and 3939.1) | | |
| | | dinucleotide - reduced + | or (197257.1) | | |
| | | Oxalate’ | or (92483.1) | | |
| | | | or (3945.1) | | |
| | | | or (160287.1) | | |
| | | | or (3948.1) | | |
| | | | or (197257.2) | | |
| | | | or (3948.2)’ | | |
| ‘Transport, | h[c] + pi[c] <= | ‘H+ + Phosphate <=> H+ + | ‘(5250.4) | 0.947729366 | 0.155260367 |
| Mitochondrial’ | h[m] + pi[m]’ | Phosphate’ | or (5250.1) | | |
| | | | or (5250.3) | | |
| | | | or (5250.2)’ | | |
| ‘Glycolysis/ | 2pg[c] <= 3pg[c]’ | ‘D-Glycerate 2-phosphate <=> | ‘(669.1) | 0.837418741 | 0.231207462 |
| Gluconeogenesis’ | | 3-Phospho-D-glycerate’ | or (5223.1) | | |
| | | | or (5224.2) | | |
| | | | or (5224.1) | | |
| | | | or (669.2)’ | | |
| ‘Glycerophospholipid | atp[c] + dag_hs[c] <= | ‘ATP + diacylglycerol | ‘(9162.1) | 0.839582173 | 0.420666411 |
| Metabolism’ | adp[c] + h[c] + | (homo sapiens) <=> ADP + H+ + | or (1607.1) | | |
| | pa_hs[c]’ | phosphatidic acid (homo sapiens)’ | or (8525.2) | | |
| | | | or (160851.1) | | |
| | | | or (1608.1) | | |
| | | | or (1607.2) | | |
| | | | or (8525.1) | | |
| | | | or (8527.1) | | |
| | | | or (1606.1) | | |
| | | | or (160851.2) | | |
| | | | or (8526.1) | | |
| | | | or (8525.3) | | |
| | | | or (1607.1) | | |
| | | | or (8527.2) | | |
| | | | or (1609.1)’ | | |
| ‘Pyruvate | lac_DASH_D[c] + | ‘D-Lactate + | ‘(197257.1) | 0.91887384 | 0.532897135 |
| Metabolism’ | nad[c] <= | Nicotinamide adenine | or (197257.2)’ | | |
| | h[c] + nadh[c] + | dinucleotide <=> | | | |
| | pyr[c]’ | H+ + Nicotinamide adenine | | | |
| | | dinucleotide - reduced + | | | |
| | | Pyruvate’ | | | |
| Uptake | his_DASH_L[e] <=’ | ‘L-Histidine <=>’ | ‘(197257.1) | 0.947624975 | 0.651955006 |
| | | | or (197257.2)’ | | |
| ‘Transport, | h[e] + lac_DASH_D[e] <= | ‘H+ + D-Lactate <=> | ‘(9123.1) | 0.954522911 | 0.712930172 |
| Extracellular’ | h[c] + lac_DASH_D[c]’ | H+ + D-Lactate’ | or (6566.1) | | |
| | | | or (23539.1) | | |
| | | | or (9194.1)’ | | |
| ‘Transport, | h[e] + pyr[e] <= | ‘H+ + Pyruvate <=> | ‘(6566.1) | 0.950867116 | 0.71451893 |
| Extracellular’ | h[c] + pyr[c]’ | H+ + Pyruvate’ | or (9123.1) | | |
| | | | or (9194.1)’ | | |
| ‘Transport, | acetone[e] + h[e] <= | ‘Acetone + H+ <=> | ‘(6566.1) | 0.908122458 | 0.678781293 |
| Extracellular’ | acetone[c] + h[c]’ | Acetone + H+’ | or (9123.1) | | |
| | | | or (9194.1)’ | | |
| ‘Transport, | xylt[e] <= xylt[c]’ | ‘Xylitol <=> Xylitol’ | ‘(6566.1) | 0.936446471 | 0.731967997 |
| Extracellular’ | | | or (9123.1) | | |
| | | | or (9194.1)’ | | |

MLYCD Experiments

FIG. 8a shows MLYCD mRNA expression upon nucleofection with Non Targeting Control (NTC) and three independent siRNA constructs in K562 leukemia cells (left), and cell proliferation of K562 cells (right) upon MLYCD knock-down (siRNA). FIG. 8b shows differential expression of MLYCD among the various cells-lines. FIG. 8c shows the functional inactivation of MLYCD resulted in a substantial decrease of acyl-carnitines, consistent with the expected inhibition of carnitine-palmitoyl transferase (CPT) by Malonyl-Coa. ** P-value <0.01; *** P-value <0.001.

Flux Analysis for MLYCD Knockdown

Utilizing the RPMI-8226 model, 1000 wild-type flux distributions were first obtained via Flux Balance Analysis (FBA), in which the MLYCD reaction is forced to be active at a rate that is at least 50% of the maximal flux rate it can carry. Next, the knockout flux distribution was computed via MOMA while constraining the flux through the corresponding reactions to zero. Utilizing the 1000 pre- and post-knockout flux distributions, a one-sided Wilcoxon ranksum test was applied to determine reactions whose flux has been significantly increased or decreased. In Table 7 reactions whose flux was significantly decreased are underlined. The flux of all other reactions was significantly increased. Specifically, an increase in the oxidative-branch of the pentose phosphate pathway that generates NADPH was found. NADPH is necessary in order to meet the increasing demands of the fatty acid synthesis pathway. This in turn results in a decreased flux through the reaction that generates reduced glutathione and then utilizes it to detoxify ROS.

TABLE 7

| | | One-sided |
|---|---|---|
| Metabolic | | Wilcoxon |
| Pathway | Reaction Formula | P-value |
| Pentose | g6p[c] + nadp[c] <=> | 1.28E−34 |
| Phosphate | 6pgl[c] + h[c] + nadph[c] | |
| Pathway | | |
| Pentose | 6pgc[c] + nadp[c] => | 1.28E−34 |
| Phosphate | co2[c] + nadph[c] + ru5p_DASH_D[c] | |
| Pathway | | |
| Pentose | 6pgl[c] + h2o[c] => | 1.28E−34 |
| Phosphate | 6pgc[c] + h[c] | |
| Pathway | | |
| Glutamate | gthox[c] + h[c] + nadph[c] => | 2.82E−39 |
| metabolism | 2gthrd[c] + nadp[c] | |
| Glutathione | 2gthrd[c] + h2o2[c] <=> | 6.08E−28 |
| Metabolism | gthox[c] + 2h2o[c] | |
| Fatty acid | 3h[c] + malcoa[c] + 2nadph[c] + | 1.28E−34 |
| elongation | pmtcoa[c] => co2[c] + coa[c] + | |
| | h2o[c] + 2nadp[c] + stcoa[c] | |
| Fatty acid | 3h[c] + malcoa[c] + 2nadph[c] + | 1.28E−34 |
| elongation | tdcoa[c] => co2[c] + coa[c] + | |
| | h2o[c] + 2nadp[c] + pmtcoa[c] | |
| Fatty acid | 3h[c] + malcoa[c] + 2nadph[c] + | 1.28E−34 |
| elongation | occoa[c] => co2[c] + coa[c] + | |
| | dcacoa[c] + h2o[c] + 2nadp[c] | |
| Fatty acid | dcacoa[c] + 3h[c] + malcoa[c] + | 1.28E−34 |
| elongation | 2nadph[c] => co2[c] + coa[c] + | |
| | ddcacoa[c] + h2o[c] + 2nadp[c] | |
| Fatty acid | ddcacoa[c] + 3h[c] + malcoa[c] + | 1.28E−34 |
| elongation | 2nadph[c] => co2[c] + coa[c] + | |
| | h2o[c] + 2nadp[c] + tdcoa[c] | |
| Fatty acid | accoa[c] + 9h[c] + 3malcoa[c] + | 1.28E−34 |
| elongation | 6nadph[c] => 3co2[c] + 3coa[c] + | |
| | 3h2o[c] + 6nadp[c] + occoa[c] | |
| Fatty acid | accoa[c] + 20h[c] + 7malcoa[c] + | 2.82E−39 |
| elongation | 14nadph[c] => 7co2[c] + 8coa[c] + | |
| | 6h2o[c] + hdca[c] + 14nadp[c] | |

Reconstructing Personalized Metabolic Models from Clinical Samples Obtained from Cancer Patients

Reconstructing Personalized Metabolic Models for Chemo-Sensitive and Chemo-Resistant Cancer Cell Lines:

The system was used to construct personalized metabolic models of 35 chemo-sensitive and chemo-resistant cancer cells, both cell-lines and primary cultures of cancer patients⁵⁸⁻⁶¹. Since growth rate measurements are unavailable in this case, the reconstruction process was done in a similar manner to that applied for the reconstruction of breast cancer models based on tumor biopsies expression levels. The predicted proliferation rates of the chemo-sensitive cells was found to be significantly higher than those of the chemo-resistant cells (one-sided Wilcoxon P-value=1.35e-4) in line with the observation that highly proliferating cells tend to better respond to chemotherapy⁵¹⁻⁵³.

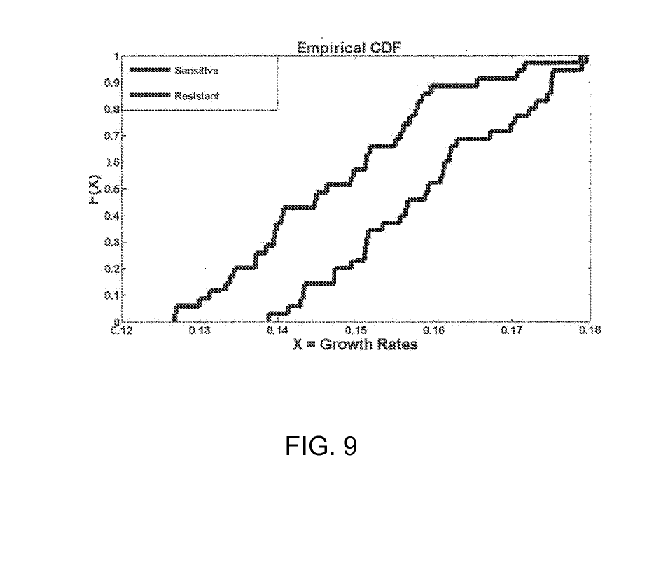

FIG. 9 shows the difference in the predicted growth rates between chemo-sensitive and chemo-resistant cancer cells as derived from their corresponding models (one-sided Wilcoxon P-value=1.35e-4). The plot represents the empirical cumulative distribution function for the predicted growth rate of the two groups.

Reconstructing Personalized Metabolic Models for Breast Cancer Patients:

TABLE 8
Summary of the Kaplan-Meyer and Cox analyses for the predicted
growth rate in the four datasets analyzed in the main text:

| | Miller | Chang | Pawitan | Curtis |
|---|---|---|---|---|
| | et al. | et al. | et al. | et al. |
| Number of patients | 236 | 295 | 159 | 1586 |
| Kaplan-Meier analysis | 4.04e−4 | 1.88e−4 | 0.03 | 5.92e−7 |
| Cox univariate analysis | 9.77e−5 | 5.59e−4 | 8.61e−4 | 7.04e−8 |
| Cox multivariate analysis | 7.89e−4 | 1.19e−5 | 0.02 | 0.02 |

Clinical predictors of breast cancer survival that were available in each of the datasets are:
Miller et al.—Age, tumor size, histological grade, lymph node status and estrogen receptor status
Chang et al.—Age, tumor size and metastasis
Pawitan et al. —Histological grade
Curtis et al.—Age, tumor size, histological grade, lymph node status and estrogen receptor status

TABLE 9
Differences in predicted growth rates between the different
clinical stages as estimated by a one-sided Wilcoxon test:

| | Miller | Pawitan | Curtis |
|---|---|---|---|
| | et al. | et al. | et al. |
| Stage 1 vs. Stage 2 | 3.3e−3 | 0.03 | 8.4e−3 |
| Stage 2 vs. Stage 3 | 1.43e−6 | 3.93e−4 | 0.01 |
| Stage 1 vs. Stage 3 | 8.29e−11 | 1.89e−5 | 1.62e−4 |

The Chang et al. dataset includes the information on whether or not the patient has developed metastasis, and it was found that patients with metastasis have a significantly lower predicted growth rate (one-sided Wilcoxon test=0.02).

Table 10 shows the predicted growth rate as a prognostic marker for patient survival when performing the analysis for each cancer stage separately and then considering treated versus non-treated patients. The results in Table 10 represent the log rank P-value and where performed using the dataset in Curtis et al.⁴² where sufficient number of samples in each group was available

TABLE 10

| | Treated | Non-treated |
|---|---|---|
| Stage 2 | 0.03 | 0.86 |
| Stage 3 | 0.03 | 0.3 |

For stage 1 patients the sample size for treated patients was too small (only 15 patients) and hence was excluded from the analysis.

Estimating the Predictive Power of the Gene Expression Derived Growth Rates in Predicting Patient Prognosis:

To examine the potential added value of personalized metabolic models in predicting patient prognosis, the survival analysis was repeated using the raw gene expression alone. The NCI-60 gene expression values of the set of genes that are most correlated to the growth rate measurements in this dataset (with FDR and α=0.05) were utilized, and multiple linear regression analysis was applied to estimate the model's parameters. The model's parameters were then used to predict the growth rates of the individual samples found in the four cohorts analyzed. Repeating the Kaplan-Meier analysis with the new estimated growth rates, a significant result was obtained only for the Chang et al. dataset (P-value=0.0023), indicating that in this dataset, high growth rate is a sign of good prognosis.

1. A processor implemented method for metabolic modeling comprising:
(a) providing:
(i) for each of p cells, a level of a predetermined quantifiable phenotype of the cell 1 under predetermined conditions;
(ii) a generic metabolic model involving reactions occurring in the p cells in which each reversible reaction in the model is decomposed into a forward direction and a backward direction, the generic metabolic model comprising a stoichiometric matrix S, where the entry Sᵢⱼ of the stoichiometric matrix S represents a stoichiometric coefficient of metabolite i in reaction j and a flux distribution v and is subject to the constraints
S·v=0 (1)
vₘᵢₙ≦v≦ (2)
wherein vₘᵢₙ and v are predetermined vectors; and
(iii) for each of two or more reactions in the generic metabolic model, an expression level of the reaction, in each cell of the p cells;
(b) a processor configured to:
(i) calculate a correlation ρ(i) between (a) the expression level of the reaction and (b) the level of the quantifiable phenotype for each reaction Ri in the generic metabolic model;
(ii) identify a set of t highly correlated reactions whose correlation with the phenotype level is above a predetermined significance threshold; and
(iii) calculate a (t×p) expression matrix, Exp-matrix, having elements Ei,j, given by
$$\begin{matrix}( iv ) {E}_{i , j} = \frac{{ρ}_{i}}{\vert {ρ}_{i} \vert} \cdot {GE}_{i , j} & ( 3 )\end{matrix} \qquad$$
where GE_{i,j} is the expression level of reaction i in the cell.

2. The method according to claim 1 wherein the processor is further configured to normalize the values of the Exp-matrix in a normalization range using a normalization procedure wherein each reaction i is normalized across the p cells so that (a) the lower bound associated with a cell having the lowest expression value is assigned the minimal value of the normalization range and (b) the upper bound associated with a cell having the highest expression value is assigned the maximal value of the normalization range.

3. The method according to claim 2 wherein the values of the Exp-matrix are normalized into the normalization range by calculating a matrix UBᵢⱼ given by the algebraic expression:
$${UB}_{i , j} = ( \frac{{E}_{i , j} - min ( {E}_{i} )}{max ( {E}_{i} ) - min ( {E}_{i} )} \cdot ( maxNormVal - minNormVal ) ) + minNormVal$$
where min(Eᵢ) is the minimal value and max(Eᵢ) is maximal value of reaction i in the p cells in the Exp-matrix, minNormVal is a minimal value of the normalization range and maxNormVal is a maximal value of the normalization range.

4. The method according to claim 3 wherein minNormVal is a minimal flux necessary for biomass production and maxNormVal is a maximal flux, necessary for biomass production.

5. The method according to claim 4 wherein minNormVal is calculated using a Flux Balance Analysis.

6. The method according to claim 4 wherein maxNormVal is calculated using a Flux Variability Analysis.

7. The method according to claim 1 wherein the expression of a reaction in a cell is the mean expression level of one or more genes encoding catalyzing enzymes of the reaction.

8. The method according to claim 1 wherein the significance threshold is calculated by a false discovery rate analysis.

9. The method according to claim 1 wherein the p cells are healthy cells.

10. The method according to claim 1 wherein the p cells are cancer cells.

11. The method according to claim 1 wherein the p cells are NCI60 cancer cells.

12. The method according to claim 1 wherein the p cells are human cells.

13. The method according to claim 1 wherein the quantifiable phenotype is a growth rate of the cell under predetermined growth conditions.

14. The method according to claim 12 wherein the p cells are cancer cells of a particular type, further comprising determining a prognosis of an individual in a method comprising:
(a) For each of the reactions i, obtaining a GEᵢ, GEᵢ being the expression value of the reaction i in a cancer cell of the particular type obtained from the individual;
(b) calculating
$${E}_{i} = \frac{{ρ}_{i}}{\vert {ρ}_{i} \vert} \cdot {GE}_{i} ;$$
(c) calculating for each of the reactions i,
$${UB}_{i} = ( \frac{{E}_{i} - min ( {E}_{i} )}{max ( {E}_{i} ) - min ( {E}_{i} )} \cdot ( maxNormVal - minNormVal ) ) + minNormVal , ;$$
and
(d) Comparing the UBᵢ with the UB_{i,j} and making a prognosis based upon the comparison.

15. The method according to claim 13 further comprising calculating a growth rate of one or more cells based on the calculated metabolic model of the one or more cell, and wherein the prognosis is obtained from a predetermined relationship of growth rate and prognosis.

16. A non-transitory computer program product, comprising computer program code for performing steps (i), (ii), and (iii) of claim 1, when said program is run on a computer.

17. A computer program as claimed in claim 16, embodied on a non-transitory computer readable medium.

18. A method for treating cancer comprising reducing a level of malonyl-CoA decarboxylase (MLYCD) in cancer cells.

19. The method according to claim 17 wherein the level of MLYCD is reduced by inhibiting expression of a gene encoding for MLYCD.

20. The method according to claim 18 wherein the expression of the gene encoding for MLYCD is inhibited using small interfering RNA.


SEQUENCE LISTING (7 sequences)

SEQ ID NO: 1 - RNA, 19 nt, Artificial Sequence
  synthetic
guaccuacaucuucaggaa

SEQ ID NO: 2 - RNA, 19 nt, Artificial Sequence
  synthetic
caaaguugacuguguucuu

SEQ ID NO: 3 - RNA, 19 nt, Artificial Sequence
  synthetic
gaaggaacauccuccauca

SEQ ID NO: 4 - DNA, 19 bp, Artificial Sequence
  synthetic
ttctgaagcacttcacacg

SEQ ID NO: 5 - DNA, 19 bp, Artificial Sequence
  synthetic
gattttgttcttctcttct

SEQ ID NO: 6 - DNA, 18 bp, Artificial Sequence
  synthetic
ttgcacgtggcactgact

SEQ ID NO: 7 - DNA, 20 bp, Artificial Sequence
  synthetic
ggatgttccttcacgattgc